(19) United States
(12) Patent Application Publication
(10) Pub. No.: US 2025/0088996 A1
(43) Pub. Date: Mar. 13, 2025

(54) DYNAMIC SUBSCRIPTION SWITCHING FOR MULTI-SUBSCRIPTION WIRELESS DEVICE

(71) Applicant: QUALCOMM Incorporated, San Diego, CA (US)

(72) Inventors: Ankit YADAV, Bengaluru (IN); Sankalp SRIVASTAVA, Bangalore (IN); Rajeshwari PATIL, Bangalore (IN)

(21) Appl. No.: 18/466,222

(22) Filed: Sep. 13, 2023

(51) Int. Cl. H04W 60/04; H04W 8/22

(52) U.S. Cl. CPC H04W 60/04; H04W 8/22

(57) ABSTRACT

Methods, systems, and devices for wireless communications are described. A user equipment (UE) may perform a first mobile network search using a first subscription and a second mobile network search using a second subscription. The UE may establish a first registration type for a first network associated with the first subscription based on the first mobile network search and establish a second registration type for a second network associated with the second subscription based on the second mobile network search. The first registration type and the second registration type may be the same or different. The UE may transmit request messages for and receive indications of first parameters associated with the first network and second parameters associated with the second network. The UE may switch a default data subscription and communicate with a network entity using the default data subscription based on the respective subscription types and the parameters.

### FIELD OF TECHNOLOGY

The following relates to wireless communications, including dynamic subscription switching for multi-subscription wireless device.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). A UE may be an example of a multi-subscription wireless device. For example, the multi-subscription wireless device may be associated with two or more subscriptions associated with two or more service providers.

### SUMMARY

The described techniques relate to improved methods, systems, devices, and apparatuses that support dynamic subscription switching for multi-subscription wireless device. For example, the described techniques enable a UE having multiple subscriber identity modules (SIMs) to perform a first mobile network search using a first subscription (e.g., a first SIM), which may be configured as a default data subscription (e.g., a default data SIM (DDS)). The UE may establish a first registration for a first network associated with the first subscription (e.g., the first SIM) based on the first mobile network search. Additionally, or alternatively, the UE may perform a second mobile network search using a second subscription (e.g., a second SIM), which may be configured as a non-default data subscription. The UE may establish a second registration for a second network associated with the second subscription (e.g., the second SIM) based on the second mobile network search, where the second registration may be of a registration type either different or the same as a registration type associated with the first registration (e.g., both home or roaming, or one home and one roaming). The UE may switch the default data subscription based on the first registration type and the second registration type. For example, the UE may switch the default data subscription if the first registration type is a roaming registration type and the second registration type is a home registration type. That is, the UE may switch the default data subscription from the first subscription, having a roaming registration type, to the second subscription, having a home registration type. The UE may communicate with a network entity of the second network using the second subscription (e.g., the second SIM) after switching the default data subscription. Additionally, or alternatively, the UE may request one or more parameters (e.g., a cost of the first SIM or the second SIM, a reference signal received power (RSRP) associated with the first network or the second network, etc.) associated with the first network and the second network when the first registration type and the second registration type are the same. For example, the UE may communicate via either the first subscription or the second subscription based on comparing the one or more parameters associated with the first network and the second network (e.g., when the first registration type and the second registration type are the same).

A method for wireless communications by a UE is described. The method may include performing a first mobile network search using a first subscription of a set of multiple subscriptions of the UE, where the first subscription is a default data subscription, establishing, using the first subscription, a first registration of the UE for a first network associated with the first subscription based on the first mobile network search, where the first registration is of a roaming registration type of a set of multiple registration types, performing a second mobile network search using a second subscription of the set of multiple subscriptions of the UE, where the second subscription is a non-default data subscription, establishing, using the second subscription, a second registration of the UE for a second network associated with the second subscription based on the second mobile network search, where the second registration is of a home registration type of the set of multiple registration types different from the roaming registration type, switching the second subscription from the non-default data subscription to the default data subscription based on the home registration type of the second registration, and communicating with a network entity of the second network using the second subscription based on the switching.

A UE for wireless communications is described. The UE may include one or more memories storing processor executable code, and one or more processors coupled with the one or more memories. The one or more processors may individually or collectively operable to execute the code to cause the UE to perform a first mobile network search using a first subscription of a set of multiple subscriptions of the UE, where the first subscription is a default data subscription, establish, using the first subscription, a first registration of the UE for a first network associated with the first subscription based on the first mobile network search, where the first registration is of a roaming registration type of a set of multiple registration types, perform a second mobile network search using a second subscription of the set of multiple subscriptions of the UE, where the second subscription is a non-default data subscription, establish, using the second subscription, a second registration of the UE for a second network associated with the second subscription based on the second mobile network search, where the second registration is of a home registration type of the set of multiple registration types different from the roaming registration type, switch the second subscription from the non-default data subscription to the default data subscription based on the home registration type of the second registration, and communicate with a network entity of the second network using the second subscription based on the switching.

Another UE for wireless communications is described. The UE may include means for performing a first mobile network search using a first subscription of a set of multiple subscriptions of the UE, where the first subscription is a default data subscription, means for establishing, using the first subscription, a first registration of the UE for a first network associated with the first subscription based on the first mobile network search, where the first registration is of a roaming registration type of a set of multiple registration types, means for performing a second mobile network search using a second subscription of the set of multiple subscriptions of the UE, where the second subscription is a non-default data subscription, means for establishing, using the second subscription, a second registration of the UE for a second network associated with the second subscription based on the second mobile network search, where the second registration is of a home registration type of the set of multiple registration types different from the roaming registration type, means for switching the second subscription from the non-default data subscription to the default data subscription based on the home registration type of the second registration, and means for communicating with a network entity of the second network using the second subscription based on the switching.

A non-transitory computer-readable medium storing code for wireless communications is described. The code may include instructions executable by a processor to perform a first mobile network search using a first subscription of a set of multiple subscriptions of the UE, where the first subscription is a default data subscription, establish, using the first subscription, a first registration of the UE for a first network associated with the first subscription based on the first mobile network search, where the first registration is of a roaming registration type of a set of multiple registration types, perform a second mobile network search using a second subscription of the set of multiple subscriptions of the UE, where the second subscription is a non-default data subscription, establish, using the second subscription, a second registration of the UE for a second network associated with the second subscription based on the second mobile network search, where the second registration is of a home registration type of the set of multiple registration types different from the roaming registration type, switch the second subscription from the non-default data subscription to the default data subscription based on the home registration type of the second registration, and communicate with a network entity of the second network using the second subscription based on the switching.

In some examples of the method, UEs, and non-transitory computer-readable medium described herein, performing the first mobile network search may include operations, features, means, or instructions for performing a search for one or more first available PLMNs for the first subscription to obtain one or more first mobile country codes (MCCs), one or more first mobile network codes (MNCs), or both associated with the one or more first available public land mobile networks (PLMNs).

In some examples of the method, UEs, and non-transitory computer-readable medium described herein, establishing the first registration may include operations, features, means, or instructions for establishing the first registration based on the one or more first MCCs, the one or more first MNCs, or both.

In some examples of the method, UEs, and non-transitory computer-readable medium described herein, performing the second mobile network search may include operations, features, means, or instructions for performing a search for one or more second available PLMNs for the second subscription to obtain one or more second MCCs, one or more second MNCs, or both associated with the one or more second available PLMNs.

In some examples of the method, UEs, and non-transitory computer-readable medium described herein, establishing the second registration may include operations, features, means, or instructions for establishing the second registration based on the one or more second MCCs, the one or more second MNCs, or both.

Some examples of the method, UEs, and non-transitory computer-readable medium described herein may further include operations, features, means, or instructions for initiating a timer based on the first registration being established as the roaming registration type of the set of multiple registration types, monitoring for one or more registration updates using the first subscription, the second subscription, or both, and switching the second subscription from the non-default data subscription to the default data subscription based on the one or more registration updates.

In some examples of the method, UEs, and non-transitory computer-readable medium described herein, the one or more registration updates include one or more MCCs, one or more MNCs, or both associated with a mobile network search using the first subscription, the second subscription, or both.

Some examples of the method, UEs, and non-transitory computer-readable medium described herein may further include operations, features, means, or instructions for receiving one or more inputs indicating a preferred default data subscription and refraining from switching the second subscription from the non-default data subscription to the default data subscription based on the one or more inputs.

In some examples of the method, UEs, and non-transitory computer-readable medium described herein, the default data subscription may be a default data SIM.

A method for wireless communications by a UE is described. The method may include performing a first mobile network search using a first subscription of a set of multiple subscriptions of the UE, establishing, using the first subscription, a first registration for a first network, where the first registration is of a first registration type of a set of multiple registration types, performing a second mobile network search using a second subscription of the set of multiple subscriptions of the UE, establishing, using the second subscription, a second registration for a second network, where the second registration is of the first registration type of the set of multiple registration types, transmitting one or more request messages to request a first set of parameters associated with the first network and to request a second set of parameters associated with the second network, receiving one or more indications of the first set of parameters and the second set of parameters in response to the one or more request messages, and communicating via the first network using the first subscription or via the second network using the second subscription based on the first set of parameters and the second set of parameters.

A UE for wireless communications is described. The UE may include one or more memories storing processor executable code, and one or more processors coupled with the one or more memories. The one or more processors may individually or collectively operable to execute the code to cause the UE to perform a first mobile network search using a first subscription of a set of multiple subscriptions of the UE, establish, using the first subscription, a first registration for a first network, where the first registration is of a first registration type of a set of multiple registration types, perform a second mobile network search using a second subscription of the set of multiple subscriptions of the UE, establish, using the second subscription, a second registration for a second network, where the second registration is of the first registration type of the set of multiple registration types, transmit one or more request messages to request a first set of parameters associated with the first network and to request a second set of parameters associated with the second network, receive one or more indications of the first set of parameters and the second set of parameters in response to the one or more request messages, and communicate via the first network using the first subscription or via the second network using the second subscription based on the first set of parameters and the second set of parameters.

Another UE for wireless communications is described. The UE may include means for performing a first mobile network search using a first subscription of a set of multiple subscriptions of the UE, means for establishing, using the first subscription, a first registration for a first network, where the first registration is of a first registration type of a set of multiple registration types, means for performing a second mobile network search using a second subscription of the set of multiple subscriptions of the UE, means for establishing, using the second subscription, a second registration for a second network, where the second registration is of the first registration type of the set of multiple registration types, means for transmitting one or more request messages to request a first set of parameters associated with the first network and to request a second set of parameters associated with the second network, means for receiving one or more indications of the first set of parameters and the second set of parameters in response to the one or more request messages, and means for communicating via the first network using the first subscription or via the second network using the second subscription based on the first set of parameters and the second set of parameters.

A non-transitory computer-readable medium storing code for wireless communications is described. The code may include instructions executable by a processor to perform a first mobile network search using a first subscription of a set of multiple subscriptions of the UE, establish, using the first subscription, a first registration for a first network, where the first registration is of a first registration type of a set of multiple registration types, perform a second mobile network search using a second subscription of the set of multiple subscriptions of the UE, establish, using the second subscription, a second registration for a second network, where the second registration is of the first registration type of the set of multiple registration types, transmit one or more request messages to request a first set of parameters associated with the first network and to request a second set of parameters associated with the second network, receive one or more indications of the first set of parameters and the second set of parameters in response to the one or more request messages, and communicate via the first network using the first subscription or via the second network using the second subscription based on the first set of parameters and the second set of parameters.

In some examples of the method, UEs, and non-transitory computer-readable medium described herein, performing the first mobile network search may include operations, features, means, or instructions for performing a search for one or more first available PLMNs for the first subscription to obtain one or more first MCCs, one or more first MNCs, or both associated with one or more first available PLMNs.

In some examples of the method, UEs, and non-transitory computer-readable medium described herein, establishing the first registration may include operations, features, means, or instructions for establishing the first registration based on the one or more first MCCs, the one or more first MNCs, or both.

In some examples of the method, UEs, and non-transitory computer-readable medium described herein, performing the second mobile network search may include operations, features, means, or instructions for performing a search for one or more second available PLMNs to obtain one or more second MCCs, one or more second MNCs, or both associated with one or more second available PLMNs.

In some examples of the method, UEs, and non-transitory computer-readable medium described herein, establishing the second registration may include operations, features, means, or instructions for establishing the second registration based on the one or more second MCCs, the one or more second MNCs, or both.

Some examples of the method, UEs, and non-transitory computer-readable medium described herein may further include operations, features, means, or instructions for comparing the first set of parameters to the second set of parameters, where the first set of parameters and the second set of parameters respectively include a first cost associated with the first subscription and a second cost associated with the second subscription.

Some examples of the method, UEs, and non-transitory computer-readable medium described herein may further include operations, features, means, or instructions for communicating via the first network using the first subscription based on the first cost associated with the first subscription being lower than the second cost associated with the second subscription by at least a threshold difference.

Some examples of the method, UEs, and non-transitory computer-readable medium described herein may further include operations, features, means, or instructions for transmitting one or more request messages to request a first strength parameter, a first performance parameter, or a first capability associated with the first network and to request a second strength parameter, a second performance parameter, or a second capability associated with the second network based on the first cost associated with the first subscription being separated from the second cost associated with the second subscription by less than a threshold difference, receiving one or more indications of the first strength parameter, the first performance parameter, or the first capability and the second strength parameter, the second performance parameter, or the second capability in response to the one or more request messages, and communicating via the first network using the first subscription based on comparing the first strength parameter, the first performance parameter, or the first capability to the second strength parameter, the second performance parameter, or the second capability.

Some examples of the method, UEs, and non-transitory computer-readable medium described herein may further include operations, features, means, or instructions for initiating one or more timers based on establishing the first registration, the second registration, or both and transmitting the one or more request messages after expiration of at least one of the one or more timers.

Some examples of the method, UEs, and non-transitory computer-readable medium described herein may further include operations, features, means, or instructions for receiving one or more inputs indicating a preferred default data subscription and refraining from communicating via the first network using the first subscription or via the second network using the second subscription based on the one or more inputs.

In some examples of the method, UEs, and non-transitory computer-readable medium described herein, the first set of parameters include a first data charge, a first strength parameter, a first performance parameter, or a first capability associated with the first subscription.

In some examples of the method, UEs, and non-transitory computer-readable medium described herein, the second set of parameters include a second data charge, a second strength parameter, a second performance parameter, or a second capability associated with the second subscription.

In some examples of the method, UEs, and non-transitory computer-readable medium described herein, the one or more request messages include an unstructured supplementary service data (USSD) query.

In some examples of the method, UEs, and non-transitory computer-readable medium described herein, the first registration type may be a home registration type.

In some examples of the method, UEs, and non-transitory computer-readable medium described herein, the first registration type may be a roaming registration type.

### BRIEF DESCRIPTION OF THE DRAWINGS

FIG. 1 shows an example of a wireless communications system that supports dynamic subscription switching for multi-subscription wireless device in accordance with one or more aspects of the present disclosure.

FIG. 2 shows an example of a wireless communications system that supports dynamic subscription switching for multi-subscription wireless device in accordance with one or more aspects of the present disclosure.

FIGS. 3 and 4 show examples of flow charts that support dynamic subscription switching for multi-subscription wireless device in accordance with one or more aspects of the present disclosure

FIGS. 5 and 6 show examples of process flows that support dynamic subscription switching for multi-subscription wireless device in accordance with one or more aspects of the present disclosure.

FIGS. 7 and 8 show block diagrams of devices that support dynamic subscription switching for multi-subscription wireless device in accordance with one or more aspects of the present disclosure.

FIG. 9 shows a block diagram of a communications manager that supports dynamic subscription switching for multi-subscription wireless device in accordance with one or more aspects of the present disclosure.

FIG. 10 shows a diagram of a system including a device that supports dynamic subscription switching for multi-subscription wireless device in accordance with one or more aspects of the present disclosure.

FIGS. 11 through 14 show flowcharts illustrating methods that support dynamic subscription switching for multi-subscription wireless device in accordance with one or more aspects of the present disclosure.

### DETAILED DESCRIPTION

In some examples, a wireless device, such as a user equipment (UE), may be a multi-subscription device having two or more subscriptions (e.g., two or more subscriber identity modules (SIMs)). A user of the UE may select a preferred subscription, or, otherwise, the device may be preconfigured to use a default subscription. The selected or default subscription may be used by the UE until the user manually changes the selection. That is, the UE may use a first subscription until the user selects a different default subscription regardless of whether the first subscription is in a home network or a roaming network. For example, a service provider (e.g., carrier) of the first subscription may support (e.g., own) one or more first networks having a first coverage area. Outside of the first coverage area, the UE may use one or more second networks (e.g., roaming networks) which are not supported by the service provider. In such cases, the user may incur additional charges (e.g., roaming charges) based on moving the UE to a roaming network for the selected subscription if the user does not manually change the subscription and use a home network.

As described herein, a UE may dynamically switch the default subscription. For example, the UE may perform a mobile network search (e.g., a public land mobile network (PLMN) search) and establish each subscription of multiple subscriptions as one of a home registration type or a roaming registration type. The UE may switch the default subscription based on the registration type associated with each subscription. For example, the UE may switch (e.g., autonomously or dynamically) the default subscription from a first subscription to a second subscription if the first subscription is established as a roaming registration type and if the second subscription is established as a home registration type. Additionally, or alternatively, the UE may obtain parameters for each network associated with each subscription and select a default subscription based on the parameters. For example, the UE may request and receive an indication of the parameters (e.g., a cost of the first SIM or the second SIM, a reference signal received power (RSRP) associated with the first network or the second network, etc.) for each network based on establishing a first subscription and a second subscription as a same registration type (i.e., both home or both roaming). In such examples, the UE may communicate via the first subscription or the second subscription based on the obtained parameters (e.g., rather than based on the registration types). For example, the UE may compare a first set of parameters (e.g., a cost, a reference signal received power (RSRP), etc.) associated with the first subscription to a second set of parameters (e.g., a cost, a reference signal received power (RSRP), etc.) associated with the second subscription.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to dynamic subscription switching for multi-subscription wireless device.

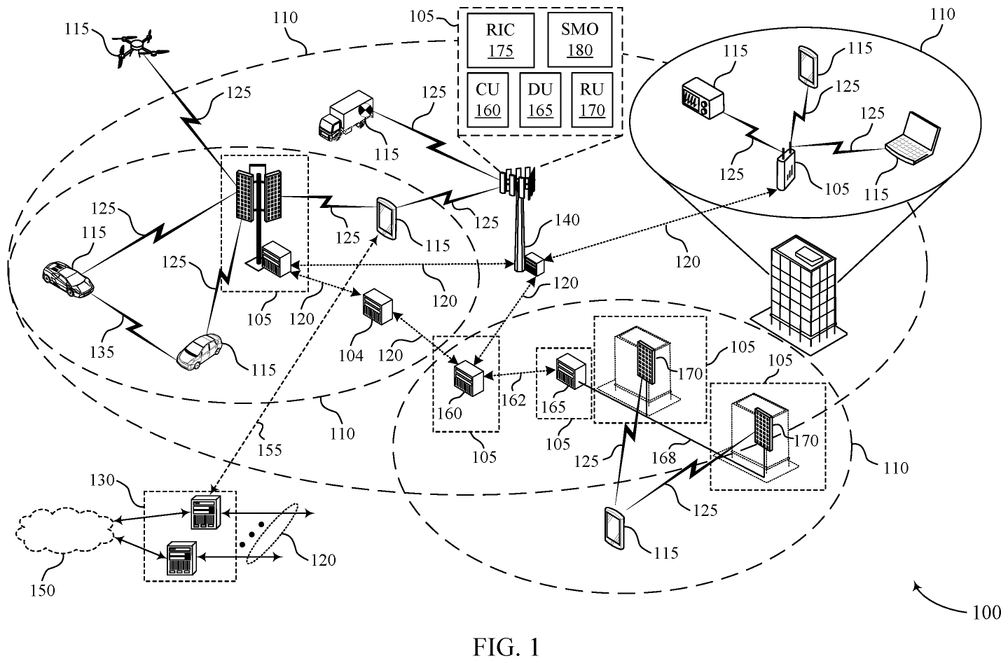

FIG. 1 shows an example of a wireless communications system 100 that supports dynamic subscription switching for multi-subscription wireless device in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support dynamic subscription switching for multi-subscription wireless device as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the UE 115, which may have multiple subscriptions (e.g., SIM1, SIM2, etc.) may perform a first mobile network search using a first subscription (e.g., a first SIM), which may be configured as a default data subscription (e.g., a default data SIM (DDS)). The UE 115 may establish a first registration for a first network associated with the first subscription (e.g., the first SIM) based on the first mobile network search. Additionally, or alternatively, the UE 115 may perform a second mobile network search using a second subscription (e.g., a second SIM) which may be configured as a non-default data subscription. The UE may establish a second registration for a second network associated with the second subscription (e.g., the second SIM) based on the second mobile network search, where the second registration may be of a registration type either different than or the same as a registration type associated with the first registration. For example, each registration type may be home or roaming, or one of the registration types may be home while the other is roaming.

The UE 115 may switch (e.g., dynamically switch) a default data subscription based on the first registration type and the second registration type. For example, the UE 115 may switch the default data subscription from the first subscription to the second subscription if the first registration type is a roaming registration type and the second registration type is a home registration type. The UE 115 may communicate with a network entity of the second network using the second subscription after the switching.

Additionally, or alternatively, the UE 115 may request sets of parameters (e.g., cost, RSRP, etc.) associated with the first network and associated with the second network, respectively. For example, the UE 115 may communicate via either the first subscription or the second subscription based on comparing the set of parameters of the first network to the set of parameters of the second network (e.g., when the first registration type and the second registration type are the same).

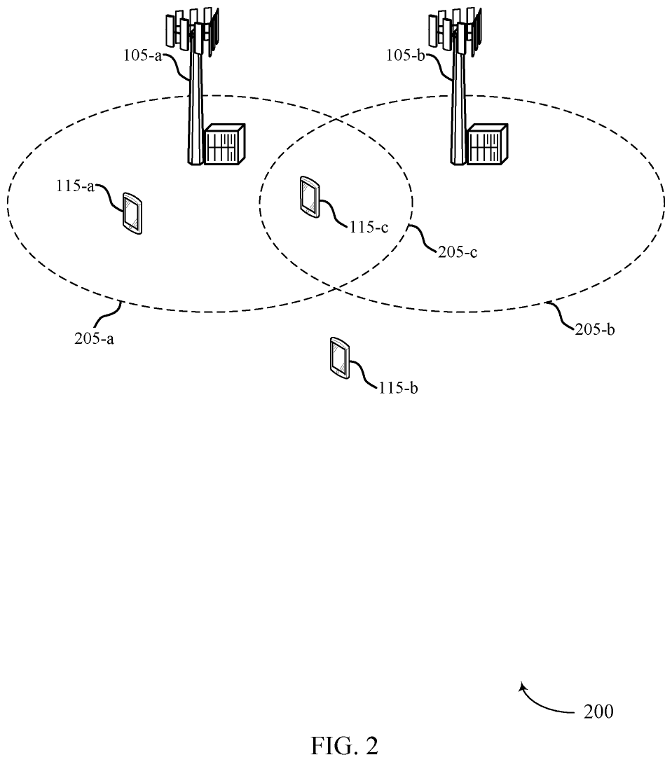

FIG. 2 shows an example of a wireless communications system 200 that supports dynamic subscription switching for multi-subscription wireless device in accordance with one or more aspects of the present disclosure. The wireless communications system 200 may implement or be implemented by aspects of the wireless communications system 100. For example, the wireless communications system 200 may include a UE 115-a, a UE 115-b, and a UE 115-c, which may represent examples of a UE 115 as described with reference to FIG. 1. The wireless communications system may also include a network entity 105-a and a network entity 105-b, which may represent examples of a network entity 105 as described with reference to FIG. 1. The UE 115-a, the UE 115-b, and the UE 115-c may be examples of multi-subscription wireless devices. In some examples, the UE 115-a, the UE 115-b, and the UE 115-c may be capable of dynamically switching between subscriptions (e.g., dynamically or autonomously switching a default subscription).

The UE 115-a may be located in a first geographic area 205-a. In some cases, the UE 115-a may perform a mobile network search (e.g., a PLMN search) using a first subscription (e.g., a first SIM) of the UE 115-a and establish a first registration having a home registration type for a network supported by the network entity 105-a. Additionally, or alternatively, the UE 115-a may perform an additional mobile network search using a second subscription (e.g., a second SIM) of the UE 115-a and establish a second registration having a roaming registration type for a network supported by the network entity 105-b. That is, for at least a portion of the first geographic area 205-a (e.g., a non-overlapping portion of the first geographic area 205-a relative to a second geographic area 205-b), the first subscription may be associated with a home registration type while the second subscription may be associated with a roaming registration type.

The UE 115-b may be in a geographic area outside the geographic areas 205-a and 205-b. For example, the UE 115-b may perform a first mobile network search using a first subscription of the UE 115-b and a second mobile network search using a second subscription of the UE 115-b. In such instances, the UE 115-b may establish both the first subscription and the second subscription with respective registrations of a roaming registration type. That is, for the geographic area outside the geographic areas 205-a and 205-b, the UE 115-b may establish a registration of a roaming registration type for the network entity 105-a (or the network entity 105-b) using both the first subscription and the second subscription.

The UE 115-c may be in a geographic area 205-c, where the geographic area 205-c may be an overlap of the first geographic area 205-a and the second geographic area 205-b. In some cases, the UE 115-c may perform a first mobile network search using a first subscription of the UE 115-c and a second mobile network search using a second subscription of the UE 115-c. In such cases, the UE 115-c may establish both the first subscription and the second subscription with respective registrations of a home registration type. That is, for the geographic area 205-c, the UE 115-c may establish a registration of a home registration type for the network entity 105-a (or the network entity 105-b) for both the first subscription and the second subscription.

In some cases, the UE 115-a, the UE 115-b, and the UE 115-c may use a default subscription based on one or more inputs from a user. That is, the UE 115-a, the UE 115-b, and the UE 115-c may use a selected or preconfigured subscription of one or more subscriptions of the UE 115-a, the UE 115-b, or the UE 115-c until one or more inputs are received that instruct the UE 115-a, the UE 115-b, or the UE 115-c to select a different default subscription.

For example, the UE 115-a may use the second subscription having a roaming registration type to communicate with the network entity 105-b while the first subscription may have a home registration type for the network entity 105-a. In some examples, a user of the UE 115-a may select the second subscription as the default subscription while in the second geographic area 205-b (i.e., a non-overlapping portion of the second geographic area 205-b) based on the second subscription having a home registration type in the second geographic area 205-b. However, the user may move the UE 115-a to the first geographic area 205-a (i.e., the non-overlapping portion of the first geographic area 205-a) where the second subscription may be associated with a roaming registration type. In such cases, the user of the UE 115-a may incur roaming charges for using the second subscription in roaming within the geographic area 205-a.

Additionally, or alternatively, the UE 115-b or the UE 115-c may each use a first subscription of the UE 115-b or the UE 115-c while the first subscription and the second subscription are associated with a same registration type (e.g., either both home or both roaming). In some cases, a user of the UE 115-b or the UE 115-c may select the first subscription as a default subscription. However, a user of the UE 115-b or the UE 115-c may incur excessive charges for using the first subscription in cases where, for example, the first subscription may be associated with higher charges than the second subscription. Additionally, or alternatively, the first subscription may be associated with a lower performance level than the second subscription in some cases. That is, the user of the UE 115-b or the UE 115-c may experience a lower relative performance level when the default subscription is not manually changed.

As described herein, the UE 115-a, the UE 115-b, and the UE 115-c may dynamically switch a default subscription. For example, the UE 115-a, the UE 115-b, and the UE 115-c may dynamically switch the default subscription based on the respective registration types of each subscription of the UE 115-a, the UE 115-b, and the UE 115-c, one or more parameters (e.g., charges, performance parameters, etc.) associated with each subscription of the UE 115-a, the UE 115-b, and the UE 115-c, or both. In such examples, the UE 115-a, the UE 115-b, and the UE 115-c may avoid incurring excessive charges and improve communication performance and reliability.

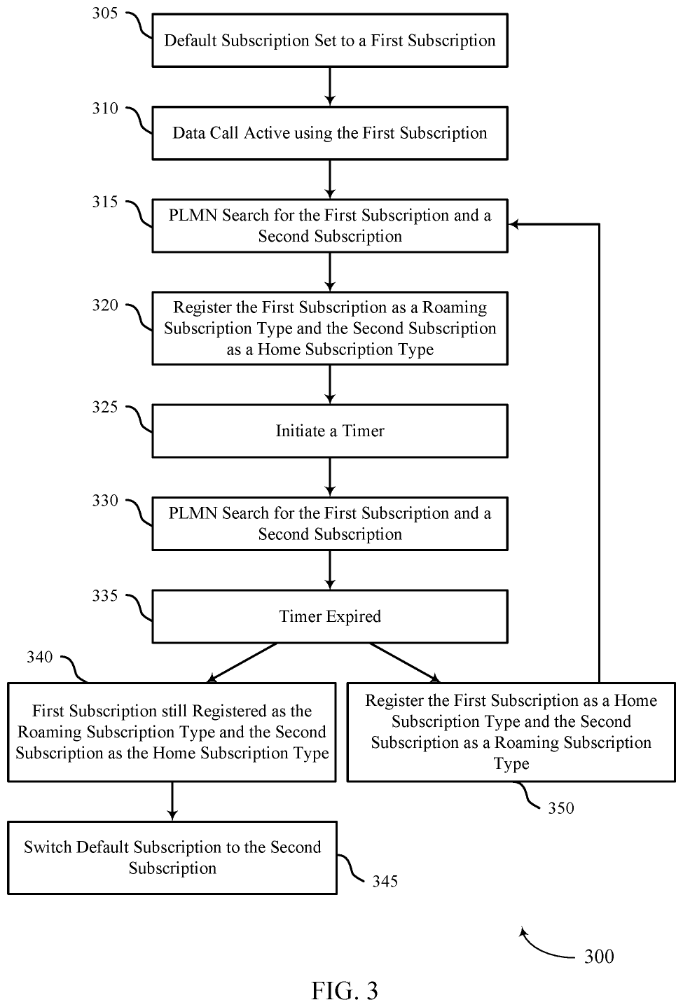

FIG. 3 shows an example of a flow chart 300 that supports dynamic subscription switching for multi-subscription wireless device in accordance with one or more aspects of the present disclosure. In some examples, the flow chart 300 may implement or be implemented by aspects of the wireless communications system 100 and the wireless communications system 200 as described with reference to FIG. 1 and FIG. 2. For example, the flow chart 300 may be implemented by a UE, which may be an example of the UE 115, the UE 115-a, the UE 115-b, and the UE 115-c as described with reference to FIG. 1 and FIG. 2. Alternative examples of the following may be implemented, where some steps are performed in a different order than described or are not performed at all. In some cases, steps may include additional features not mentioned below, or further steps may be added.

At 305, the UE may set a default subscription to a first subscription. For example, the UE may be an example of a multi-subscription wireless device where the UE is associated with at least the first subscription (e.g., SIM1) and a second subscription (e.g., SIM2).

At 310, the UE may perform a data call using the first subscription. For example, the first subscription may be set as a default subscription for the UE such that the UE may use the first subscription to communicate with one or more other wireless devices.

At 315, the UE may perform a PLMN search for the first subscription and the second subscription. For example, the UE may monitor for updates associated with a mobile network code (MNC), mobile country code (MCC), or both for the first subscription and the second subscription. In some examples, a system information block (SIB) may include the MNC, the MCC, or both for the first subscription and the second subscription, respectively. That is, a first SIB (e.g., SIB1) associated with the first subscription may include the MNC, the MCC, or both associated with the first subscription while a second SIB (e.g., SIB2) associated with the second subscription may include the MNC, the MCC, or both associated with the second subscription.

At 320, the UE may register the first subscription as a roaming subscription type and the second subscription as a home subscription type. For example, the UE may establish a first registration (e.g., of a roaming subscription type) for the first subscription with a first network entity and establish a second registration (e.g., of a home subscription type) for the second subscription with a second network entity based on the PLMN search for the first subscription and the second subscription. In some examples, the UE may register the first subscription, the second subscription, or both to a home PLMN (e.g., if a home PLMN is available for a respective subscription), or, otherwise, a roaming PLMN associated with a relatively high performance parameter (e.g., a reference signal received power (RSRP) value). That is, the first network entity may be an example of a roaming PLMN for the first subscription while the second network entity may be an example of a home PLMN for the second subscription.

At 325, the UE may initiate a timer. For example, the UE may initiate a timer based on the roaming registration type of the first subscription (i.e., the default subscription) and the home registration type of the second subscription (i.e., a non-default subscription). That is, the UE may refrain from dynamically switching the default subscription based on the timer being below a threshold (e.g., before the timer expires).

At 330, the UE may perform an additional PLMN search for the first subscription and the second subscription. That is, the UE may perform the additional PLMN search for the first subscription and the second subscription to confirm respective subscription types for the first subscription and the second subscription prior to expiration of the timer.

At 335, the timer may expire. For example, the UE may dynamically switch the default subscription based on the expiration of the timer and the results of the additional PLMN search for the first subscription and the second subscription.

At 340, the UE may register the first subscription as the roaming subscription type and the second subscription as the home subscription type. That is, the respective subscription types of the first subscription and the second subscription may be the same for the PLMN search at 315 and the additional PLMN search at 330.

In such cases, at 345, the UE may switch the default subscription to the second subscription. That is, the UE may switch the default subscription to the second subscription based on the first subscription being a roaming subscription type and the second subscription being a home subscription type for at least the duration of the timer.

Additionally, or alternatively, at 350, the UE may register the first subscription as a home subscription type and the second subscription as a roaming subscription type. That is, the respective subscription types of the first subscription and the second subscription may be different for the PLMN search at 315 and the additional PLMN search at 330. In such cases, the UE may refrain from switching the default subscription from the first subscription to the second subscription. In some examples, the UE may then perform the PLMN search at 315. That is, the UE may monitor for a change in the registration type of the first subscription and the second subscription based on the MNC and MCC associated with each subscription.

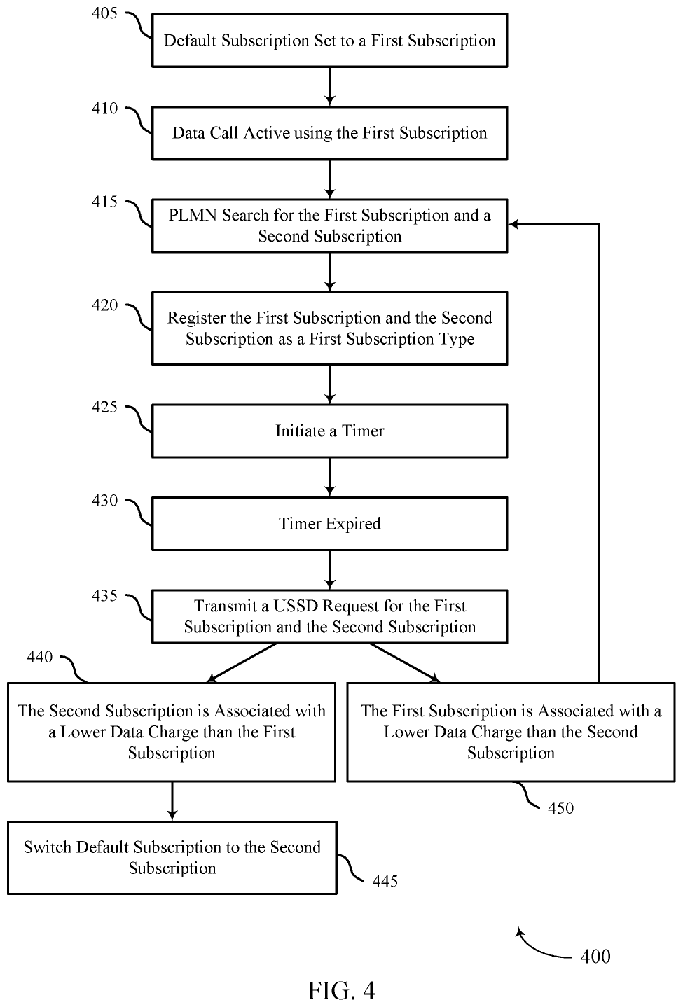

FIG. 4 shows an example of a flow chart 400 that supports dynamic subscription switching for multi-subscription wireless device in accordance with one or more aspects of the present disclosure. In some examples, the flow chart 400 may implement or be implemented by aspects of the wireless communications system 100 and the wireless communications system 200 as described with reference to FIG. 1 and FIG. 2. For example, the flow chart 400 may be implemented by a UE, which may be an example of the UE 115, the UE 115-a, the UE 115-b, and the UE 115-c as described with reference to FIG. 1 and FIG. 2. Alternative examples of the following may be implemented, where some steps are performed in a different order than described or are not performed at all. In some cases, steps may include additional features not mentioned below, or further steps may be added.

At 405, the UE may set a default subscription to a first subscription. For example, the UE may be an example of a multi-subscription wireless device where the UE is associated with at least the first subscription (e.g., SIM1) and a second subscription (e.g., SIM2).

At 410, the UE may perform a data call using the first subscription. For example, the first subscription may be set as a default subscription for the UE such that the UE may use the first subscription to communicate with one or more other wireless devices.

At 415, the UE may perform a PLMN search for the first subscription and the second subscription. For example, the UE may monitor for updates associated with a mobile network code (MNC), mobile country code (MCC), or both for the first subscription and the second subscription. In some examples, a system information block (SIB) may include the MNC, the MCC, or both for the first subscription and the second subscription, respectively. That is, a first SIB (e.g., SIB1) associated with the first subscription may include the MNC, the MCC, or both associated with the first subscription while a second SIB (e.g., SIB2) associated with the second subscription may include the MNC, the MCC, or both associated with the second subscription.

At 420, the UE may register the first subscription and the second subscription as a first subscription type (e.g., a roaming subscription type or a home subscription type). For example, the UE may establish a first registration for the first subscription with a first network entity and establish a second registration for the second subscription with a second network entity based on the PLMN search for the first subscription and the second subscription. That is, the UE may establish the first registration and the second registration, where the first registration and the second registration are of a same subscription type.

In some examples, the UE may register the first subscription, the second subscription, or both to a home PLMN (e.g., if a home PLMN is available for a respective subscription), or, otherwise, a roaming PLMN associated with a relatively high performance parameter (e.g., a reference signal received power (RSRP) value). That is, the first network entity, the second network entity, or both may be examples of a roaming PLMN or a home PLMN for the first subscription, the second subscription, or both.

At 425, the UE may initiate a timer. For example, the UE may initiate a timer based on the first subscription type of the first subscription and the second subscription. That is, the UE may refrain from dynamically switching the default subscription based on the timer being below a threshold (e.g., before the timer expires).

At 430, the timer may expire. For example, the UE may dynamically switch the default subscription based on the expiration of the timer and a respective subscription type associated with the first subscription and the second subscription. Or, the UE may refrain from transmitting an unstructured supplementary service data (USSD) request until the expiration of the timer based on the subscription type associated with the first subscription and the second subscription (i.e., based on a same subscription type for the first subscription and the second subscription).

At 435, the UE may transmit the USSD request for the first subscription and the second subscription. For example, the UE may perform a USSD query for the first subscription and the second subscription to compare one or more parameters (e.g., charges associated with data and voice usage, radio access technology (RAT) strength, performance, capability, etc.) associated with each subscription.

At 440, the UE may determine that the second subscription may be associated with a lower data charge than the first subscription. For example, the UE may receive one or more responses to the transmitted USSD request (i.e., the USSD query) including a first data charge associated with the first subscription and a second data charge associated with the second subscription. The UE may compare the first data charge and the second data charge. For example, the UE may determine a difference between a higher data charge (e.g., the first data charge) and a lower data charge (e.g., the second data charge).

In some examples, the difference between the higher data charge and the lower data charge may be below a threshold difference. For example, the difference may be relatively small (e.g., below the threshold) such that the UE may compare one or more other parameters (e.g., RAT strength, performance, capability, etc.) associated with the first subscription and the second subscription. In some examples, the UE may receive the one or more other parameters associated with the first subscription and the second subscription via the one or more responses to the USSD request.

At 445, the UE may switch the default subscription to the second subscription. That is, the UE may switch the default subscription to the second subscription based on the second data charge associated with the second subscription being lower than the first data charge associated with the first subscription by at least the threshold difference. Or, the UE may switch the default subscription to the second subscription based on comparing one or more other parameters associated with the first subscription and the second subscription.

Additionally, or alternatively, at 450, the UE may determine that the first subscription is associated with a lower data charge than the second subscription. For example, the UE may receive the one or more responses to the transmitted USSD request (i.e., the USSD query) including the first data charge associated with the first subscription and the second data charge associated with the second subscription. The UE may compare the first data charge and the second data charge. For example, the UE may determine a difference between a higher data charge (e.g., the second data charge) and a lower data charge (e.g., the first data charge).

In such cases, the UE may refrain from switching the default subscription and the UE may then perform the PLMN search at 415. That is, the UE may monitor for a change in the registration type of the first subscription and the second subscription based on the MNC and MCC associated with each subscription.

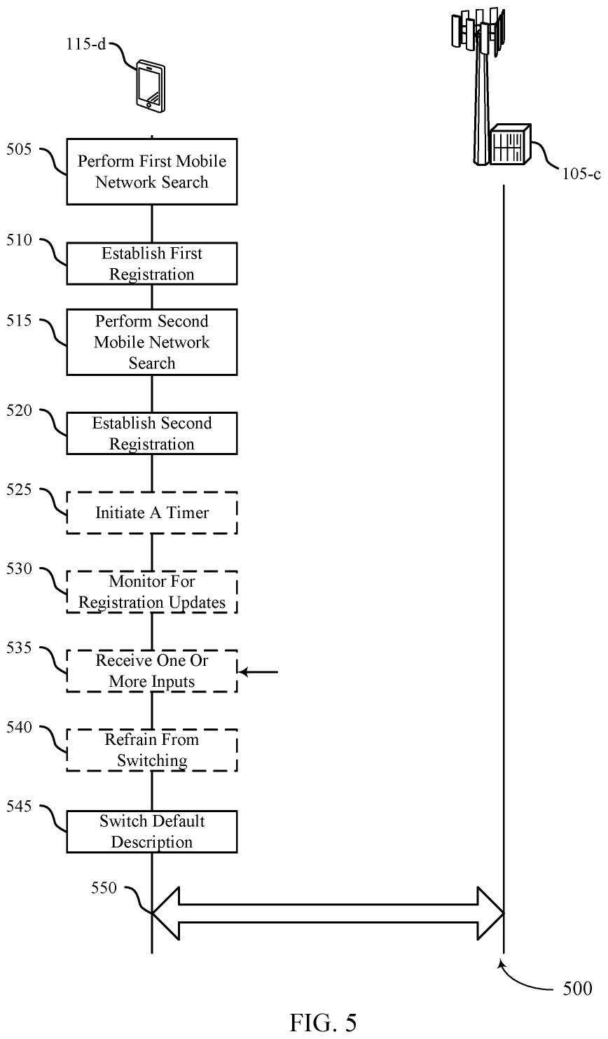

FIG. 5 shows an example of a process flow 500 that supports dynamic subscription switching for multi-subscription wireless device in accordance with one or more aspects of the present disclosure. In some examples, the process flow 500 may implement or be implemented by aspects of the wireless communications system 100 and the wireless communications system 200 as described with reference to FIG. 1 and FIG. 2. For example, the process flow 500 may include a UE 115-d and a network entity 105-c, which may be examples of corresponding devices as described with reference to FIGS. 1-4. Alternative examples of the following may be implemented, where some steps are performed in a different order than described or are not performed at all. In some cases, steps may include additional features not mentioned below, or further steps may be added. Although the UE 115-d and the network entity 105-d are shown performing the operations of the process flow 500, some aspects of some operations may also be performed by one or more other wireless devices.

At 505, the UE 115-d may perform a first mobile network search. For example, the UE 115-d may perform the first mobile network search using a first subscription of a quantity of subscriptions of the UE 115-d. In some examples, the first subscription may be a default data subscription. For example, the first subscription may be an example of a SIM. Additionally, or alternatively, the default data subscription may be an example of a DDS.

In some examples, the first mobile network search may include a search for one or more first available PLMNs for the first subscription (e.g., a PLMN search). For example, the UE 115-d may perform the PLMN search to obtain one or more first MCCs, one or more first MNCs, or both associated with the one or more first available PLMNs.

At 510, the UE 115-d may establish a first registration. For example, the UE 115-d may establish the first registration of the UE 115-d using the first subscription. In some examples, the first registration may be for a first network associated with the first subscription based on the first mobile network search. The first registration may be a roaming registration type of a quantity of registration types.

In some examples, the UE 115-d may establish the first registration based on the one or more first MCCs, the one or more first MNCs, or both.

At 515, the UE 115-d may perform a second mobile network search. For example, the UE 115-d may perform the second mobile network search using a second subscription of a quantity of subscriptions of the UE 115-d. In some examples, the second subscription may be a non-default data subscription. For example, the second subscription may be an example of a SIM.

In some examples, the second mobile network search may include a search for one or more second available PLMNs for the second subscription (e.g., a PLMN search). For example, the UE 115-d may perform the PLMN search to obtain one or more second MCCs, one or more second MNCs, or both associated with the one or more second available PLMNs.

At 520, the UE 115-d may establish a second registration. For example, the UE 115-d may establish the second registration of the UE 115-d using the second subscription. In some examples, the second registration may be for a second network associated with the second subscription based on the second mobile network search. The second registration may be a home registration type of a quantity of registration types. For example, the home registration type may be different than the roaming registration type.

In some examples, the UE 115-d may establish the second registration based on the one or more second MCCs, the one or more second MNCs, or both.

At 525, the UE 115-d may initiate a timer. For example, the UE 115-d may initiate a timer based on the first registration being established as the roaming registration type of the quantity of registration types. The UE 115-d may switch the default subscription after the default subscription may be associated with the roaming registration type for a threshold period of time.

At 530, the UE 115-d may monitor for registration updates. For example, the UE 115-d may monitor for registration updates using the first subscription, the second subscription, or both. In some examples, the UE 115-d may monitor for registration updates after initiation of the timer.

In some examples, the one or more registration updates may include one or more MCCs, one or more MNCs, or both associated with a mobile network search using the first subscription, the second subscription, or both. For example, the registration updates for the first subscription may correspond to the one or more first MCCs, the one or more first MNCs, or both while the registration updates for the second subscription may correspond to the one or more second MCCs, the one or more second MNCs, or both.

At 535, the UE 115-d may receive one or more inputs. For example, the UE 115-d may receive one or more inputs indicating a preferred default data subscription. In some examples, the default data subscription may be a DDS. Additionally, or alternatively, the one or more inputs may disable dynamic subscription switching. For example, a user of the UE 115-d may manually opt out of the dynamic subscription switching. In some examples, the UE 115-d may receive one or more additional inputs enabling the dynamic subscription switching (e.g., opting in to the dynamic subscription switching).

At 540, the UE 115-d may refrain from switching. For example, the UE 115-d may refrain from switching the second subscription from the non-default data subscription to the default data subscription based at least in part on the one or more inputs. The one or more inputs may disable the dynamic subscription switching at the UE 115-d.

At 545, the UE 115-d may switch a default subscription. For example, the UE 115-d may switch the second subscription from the non-default data subscription to the default data subscription based on the home registration type of the second registration. In some cases, the switch may be a dynamic switch based on the first mobile network search and the second mobile network search (e.g., PLMN searches).

At 550, the UE 115-d may communicate with the network entity 105-c. For example, the network entity 105-c may be of the second network, where the second registration of the UE 115-d for the second network is associated with the second subscription based on the second mobile network search. The UE 115-d may communicate with the network entity 105-c using the second subscription based on the switching.

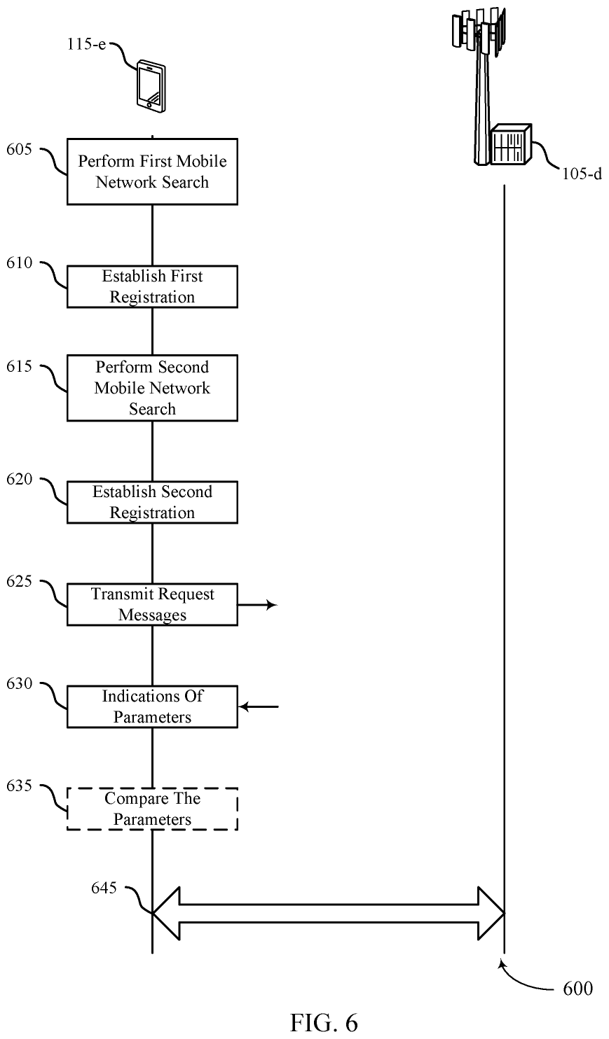

FIG. 6 shows an example of a process flow 600 that supports dynamic subscription switching for multi-subscription wireless device in accordance with one or more aspects of the present disclosure. In some examples, the process flow 600 may implement or be implemented by aspects of the wireless communications system 100 and the wireless communications system 200 as described with reference to FIG. 1 and FIG. 2. For example, the process flow 600 may include a UE 115-e and a network entity 105-d, which may be examples of corresponding devices as described with reference to FIGS. 1-4. Alternative examples of the following may be implemented, where some steps are performed in a different order than described or are not performed at all. In some cases, steps may include additional features not mentioned below, or further steps may be added. Although the UE 115-e and the network entity 105-d are shown performing the operations of the process flow 600, some aspects of some operations may also be performed by one or more other wireless devices.

At 605, the UE 115-e may perform a first mobile network search. For example, the UE 115-e may perform the first mobile network search using a first subscription of a quantity of subscriptions of the UE 115-e. In some examples, the first subscription may be an example of a SIM.

In some examples, the first mobile network search may include a search for one or more first available PLMNs for the first subscription (e.g., a PLMN search). For example, the UE 115-e may perform the PLMN search to obtain one or more first MCCs, one or more first MNCs, or both associated with the one or more first available PLMNs.

At 610, the UE 115-e may establish a first registration. For example, the UE 115-e may establish the first registration of the UE 115-e using the first subscription. In some examples, the first registration may be for a first network associated with the first subscription based on the first mobile network search. The first registration may be a first registration type of a quantity of registration types.

In some examples, the UE 115-e may establish the first registration based on the one or more first MCCs, the one or more first MNCs, or both.

At 615, the UE 115-e may perform a second mobile network search. For example, the UE 115-e may perform the second mobile network search using a second subscription of a quantity of subscriptions of the UE 115-e. In some examples, the second subscription may be an example of a SIM.

In some examples, the second mobile network search may include a search for one or more second available PLMNs for the second subscription (e.g., a PLMN search). For example, the UE 115-e may perform the PLMN search to obtain one or more second MCCs, one or more second MNCs, or both associated with the one or more second available PLMNs.

At 620, the UE 115-e may establish a second registration. For example, the UE 115-e may establish the second registration of the UE 115-e using the second subscription. In some examples, the second registration may be for a second network associated with the second subscription based on the second mobile network search. The second registration may be the first registration type of a quantity of registration types. For example, the first registration and the second registration may be of a same registration type (e.g., a home registration type or a roaming registration type).

In some examples, the UE 115-e may initiate a timer. For example, the UE 115-e may initiate a timer based on establishing the first registration, the second registration, or both. The UE 115-e may switch the default subscription after a threshold period of time.

Additionally, or alternatively, the UE 115-e may monitor for registration updates. For example, the UE 115-e may monitor for registration updates using the first subscription, the second subscription, or both. In some examples, the UE 115-e may monitor for registration updates after initiation of the timer.

In some examples, the one or more registration updates may include one or more MCCs, one or more MNCs, or both associated with a mobile network search using the first subscription, the second subscription, or both. For example, the registration updates for the first subscription may correspond to the one or more first MCCs, the one or more first MNCs, or both while the registration updates for the second subscription may correspond to the one or more second MCCs, the one or more second MNCs, or both.

Additionally, or alternatively, the UE 115-e may receive one or more inputs. For example, the UE 115-e may receive one or more inputs indicating a preferred default data subscription. In some examples, the default data subscription may be a DDS. Additionally, or alternatively, the one or more inputs may disable dynamic subscription switching. For example, a user of the UE 115-e may manually opt out of the dynamic subscription switching. In some examples, the UE 115-e may receive one or more additional inputs enabling the dynamic subscription switching (e.g., opting in to the dynamic subscription switching).

In some examples, the UE 115-e may refrain from switching. For example, the UE 115-e may refrain from switching the first subscription or second subscription from the non-default data subscription to the default data subscription based at least in part on the one or more inputs. The one or more inputs may disable the dynamic subscription switching at the UE 115-e.

At 625, the UE 115-e may transmit request messages. For example, the UE 115-e may transmit one or more request messages to request a first set of parameters associated with the first network and to request a second set of parameters associated with the second network. In some examples, the one or more request messages may be transmitted by the UE 115-e as a USSD query.

In some examples, the first set of parameters may include a first cost associated with the first subscription while the second set of parameters may include a second cost associated with the second subscription. For example, the UE 115-e may consider a cost (e.g., data charges) associated with each subscription based on the registration type of each subscription being the same.

In some examples, the UE 115-e may transmit the one or more request messages to request a first strength parameter, a first performance parameter, or a first capability associated with the first network and to request a second strength parameter, a second performance parameter, or a second capability associated with the second network. For example, the UE 115-e may consider parameters different than cost associated with a subscription.

At 630, the UE 115-e may receive indications of parameters. For example, the UE 115-e may receive one or more indications of the first set of parameters and the second set of parameters in response to the one or more request messages. In some examples, the one or more indications may include the first cost, the second cost, the first strength parameter, the first performance parameter, the first capability, the second strength parameter, the second performance parameter, the second capability, or a combination thereof. Additionally, or alternatively, the one or more indications may be a response to the USSD query.

At 635, the UE 115-e may compare the parameters. For example, the UE 115-e may compare the first set of parameters to the second set of parameters. In some examples, the UE 115-e may compare the first cost and the second cost, where the first cost may be lower than the second cost by a difference.

In some examples, the UE 115-e may compare the first strength parameter, the first performance parameter, or the first capability to the second strength parameter, the second performance parameter, or the second capability. For example, the UE 115-e may compare one or more parameters different from the first cost and the second cost based on the difference between the first cost and the second cost being below a threshold.

In some examples, the UE 115-e may switch a default subscription. For example, the UE 115-e may switch the default subscription based on the comparing. That is, the UE 115-e may switch the default subscription based on the first cost being lower than the second cost by the difference, where the difference at least exceeds the threshold difference. Or, the UE 115-e may switch the default subscription based on comparing one or more other parameters (e.g., strength, performance, capability, etc.) of the first subscription, the second subscription, or both.

At 645, the UE 115-e may communicate with the network entity 105-d. For example, the UE 115-e may communicate with the network entity 105-d using the first subscription, where the network entity 105-d may be of the first network associated with the first registration of the UE 115-e. Additionally, or alternatively, the UE 115-e may communicate with the network entity 105-d using the second subscription, where the network entity 105-d may be of the second network associated with the second registration of the UE 115-e.

The UE 115-e may communicate with the network entity 105-d based on the first set of parameters and the second set of parameters. For example, the UE 115-e may communicate with the network entity 105-d based on the first cost associated with the first subscription being lower than the second cost associated with the second subscription by at least the threshold difference. Additionally, or alternatively, the UE 115-e may communicate with the network entity 105-d based on comparing one or more other parameters (e.g., strength, performance, capability) associated with the first subscription, the second subscription, or both. That is, the UE 115-e may communicate with the network entity 105-d based on the comparing.

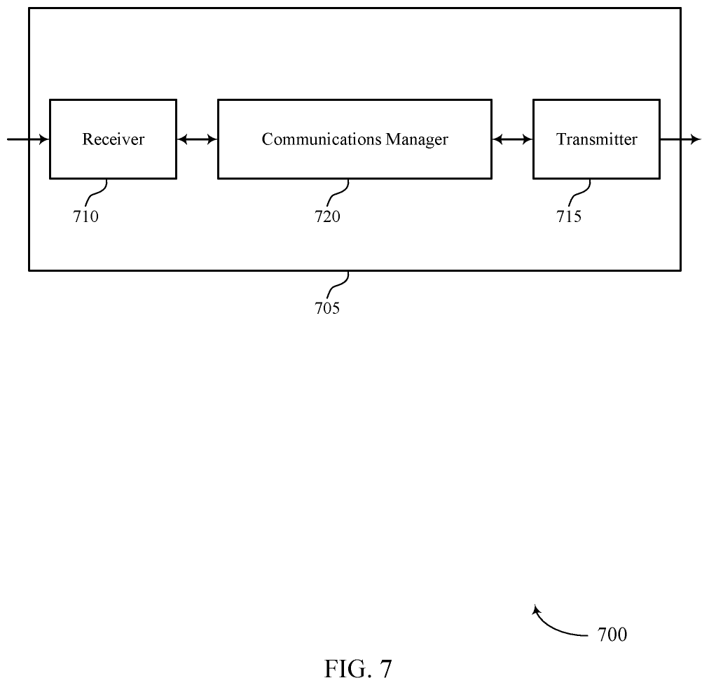

FIG. 7 shows a block diagram 700 of a device 705 that supports dynamic subscription switching for multi-subscription wireless device in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to dynamic subscription switching for multi-subscription wireless device). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to dynamic subscription switching for multi-subscription wireless device). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of dynamic subscription switching for multi-subscription wireless device as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for performing a first mobile network search using a first subscription of a set of multiple subscriptions of the UE, where the first subscription is a default data subscription. The communications manager 720 is capable of, configured to, or operable to support a means for establishing, using the first subscription, a first registration of the UE for a first network associated with the first subscription based on the first mobile network search, where the first registration is of a roaming registration type of a set of multiple registration types. The communications manager 720 is capable of, configured to, or operable to support a means for performing a second mobile network search using a second subscription of the set of multiple subscriptions of the UE, where the second subscription is a non-default data subscription. The communications manager 720 is capable of, configured to, or operable to support a means for establishing, using the second subscription, a second registration of the UE for a second network associated with the second subscription based on the second mobile network search, where the second registration is of a home registration type of the set of multiple registration types different from the roaming registration type. The communications manager 720 is capable of, configured to, or operable to support a means for switching the second subscription from the non-default data subscription to the default data subscription based on the home registration type of the second registration. The communications manager 720 is capable of, configured to, or operable to support a means for communicating with a network entity of the second network using the second subscription based on the switching.

Additionally, or alternatively, the communications manager 720 may support wireless communications in accordance with examples as disclosed herein. For example, the communications manager 720 is capable of, configured to, or operable to support a means for performing a first mobile network search using a first subscription of a set of multiple subscriptions of the UE. The communications manager 720 is capable of, configured to, or operable to support a means for establishing, using the first subscription, a first registration for a first network, where the first registration is of a first registration type of a set of multiple registration types. The communications manager 720 is capable of, configured to, or operable to support a means for performing a second mobile network search using a second subscription of the set of multiple subscriptions of the UE. The communications manager 720 is capable of, configured to, or operable to support a means for establishing, using the second subscription, a second registration for a second network, where the second registration is of the first registration type of the set of multiple registration types. The communications manager 720 is capable of, configured to, or operable to support a means for transmitting one or more request messages to request a first set of parameters associated with the first network and to request a second set of parameters associated with the second network. The communications manager 720 is capable of, configured to, or operable to support a means for receiving one or more indications of the first set of parameters and the second set of parameters in response to the one or more request messages. The communications manager 720 is capable of, configured to, or operable to support a means for communicating via the first network using the first subscription or via the second network using the second subscription based on the first set of parameters and the second set of parameters.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

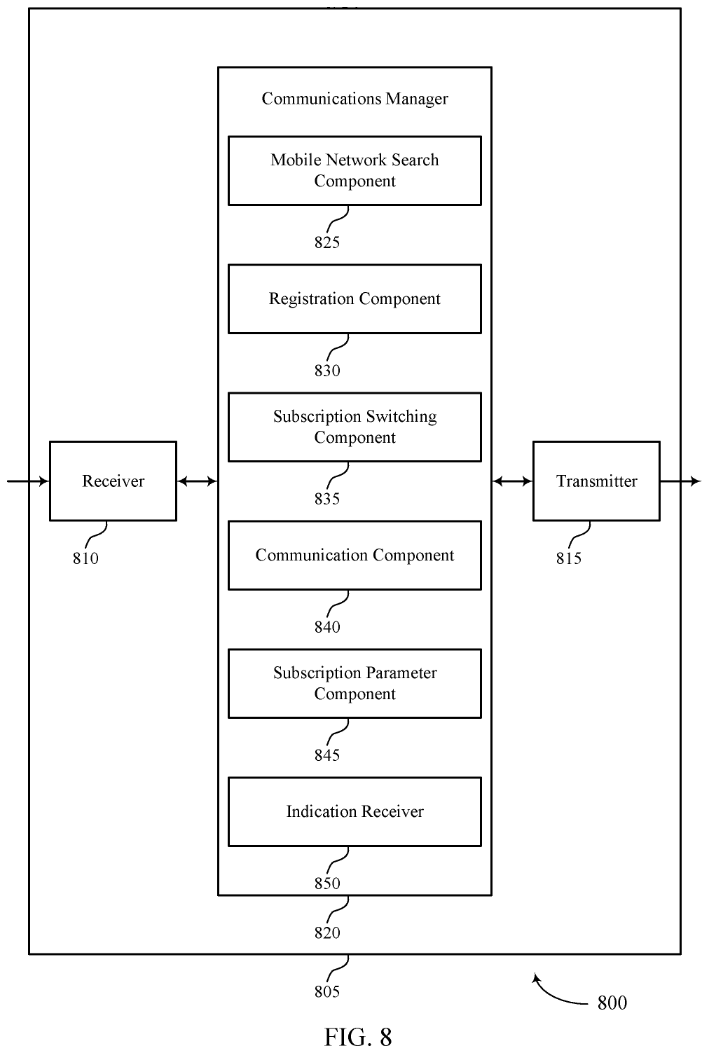

FIG. 8 shows a block diagram 800 of a device 805 that supports dynamic subscription switching for multi-subscription wireless device in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to dynamic subscription switching for multi-subscription wireless device). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to dynamic subscription switching for multi-subscription wireless device). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of dynamic subscription switching for multi-subscription wireless device as described herein. For example, the communications manager 820 may include a mobile network search component 825, a registration component 830, a subscription switching component 835, a communication component 840, a subscription parameter component 845, an indication receiver 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The mobile network search component 825 is capable of, configured to, or operable to support a means for performing a first mobile network search using a first subscription of a set of multiple subscriptions of the UE, where the first subscription is a default data subscription. The registration component 830 is capable of, configured to, or operable to support a means for establishing, using the first subscription, a first registration of the UE for a first network associated with the first subscription based on the first mobile network search, where the first registration is of a roaming registration type of a set of multiple registration types. The mobile network search component 825 is capable of, configured to, or operable to support a means for performing a second mobile network search using a second subscription of the set of multiple subscriptions of the UE, where the second subscription is a non-default data subscription. The registration component 830 is capable of, configured to, or operable to support a means for establishing, using the second subscription, a second registration of the UE for a second network associated with the second subscription based on the second mobile network search, where the second registration is of a home registration type of the set of multiple registration types different from the roaming registration type. The subscription switching component 835 is capable of, configured to, or operable to support a means for switching the second subscription from the non-default data subscription to the default data subscription based on the home registration type of the second registration. The communication component 840 is capable of, configured to, or operable to support a means for communicating with a network entity of the second network using the second subscription based on the switching.

Additionally, or alternatively, the communications manager 820 may support wireless communications in accordance with examples as disclosed herein. The mobile network search component 825 is capable of, configured to, or operable to support a means for performing a first mobile network search using a first subscription of a set of multiple subscriptions of the UE. The registration component 830 is capable of, configured to, or operable to support a means for establishing, using the first subscription, a first registration for a first network, where the first registration is of a first registration type of a set of multiple registration types. The mobile network search component 825 is capable of, configured to, or operable to support a means for performing a second mobile network search using a second subscription of the set of multiple subscriptions of the UE. The registration component 830 is capable of, configured to, or operable to support a means for establishing, using the second subscription, a second registration for a second network, where the second registration is of the first registration type of the set of multiple registration types. The subscription parameter component 845 is capable of, configured to, or operable to support a means for transmitting one or more request messages to request a first set of parameters associated with the first network and to request a second set of parameters associated with the second network. The indication receiver 850 is capable of, configured to, or operable to support a means for receiving one or more indications of the first set of parameters and the second set of parameters in response to the one or more request messages. The communication component 840 is capable of, configured to, or operable to support a means for communicating via the first network using the first subscription or via the second network using the second subscription based on the first set of parameters and the second set of parameters.

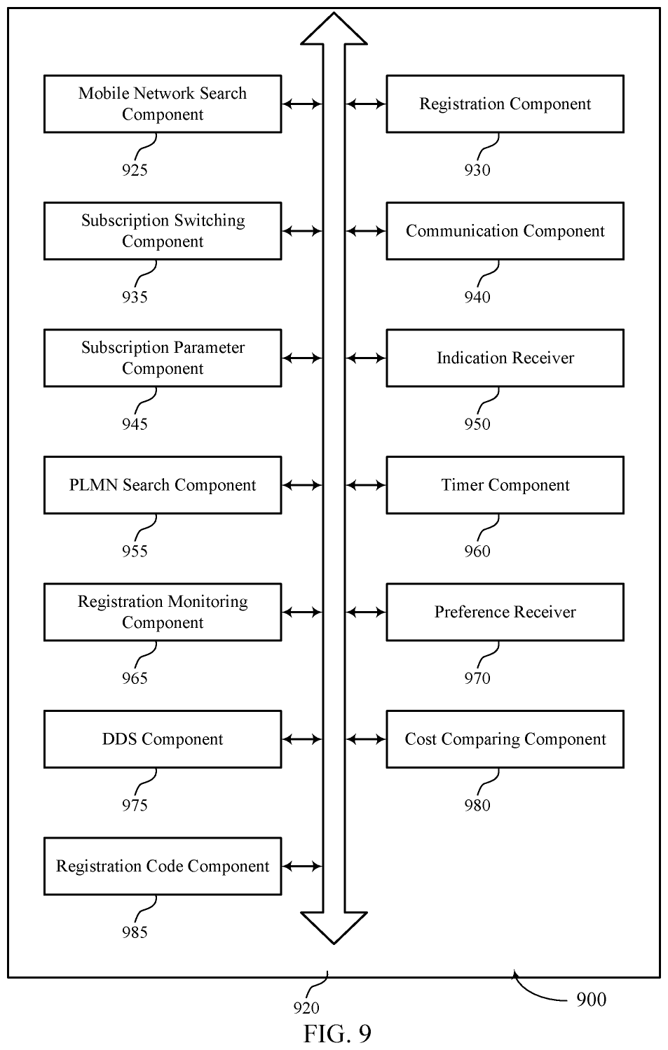

FIG. 9 shows a block diagram 900 of a communications manager 920 that supports dynamic subscription switching for multi-subscription wireless device in accordance with one or more aspects of the present disclosure. The communications manager 920 may be an example of aspects of a communications manager 720, a communications manager 820, or both, as described herein. The communications manager 920, or various components thereof, may be an example of means for performing various aspects of dynamic subscription switching for multi-subscription wireless device as described herein. For example, the communications manager 920 may include a mobile network search component 925, a registration component 930, a subscription switching component 935, a communication component 940, a subscription parameter component 945, an indication receiver 950, an PLMN search component 955, a timer component 960, a registration monitoring component 965, a preference receiver 970, a DDS component 975, a cost comparing component 980, a registration code component 985, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The mobile network search component 925 is capable of, configured to, or operable to support a means for performing a first mobile network search using a first subscription of a set of multiple subscriptions of the UE, where the first subscription is a default data subscription. The registration component 930 is capable of, configured to, or operable to support a means for establishing, using the first subscription, a first registration of the UE for a first network associated with the first subscription based on the first mobile network search, where the first registration is of a roaming registration type of a set of multiple registration types. In some examples, the mobile network search component 925 is capable of, configured to, or operable to support a means for performing a second mobile network search using a second subscription of the set of multiple subscriptions of the UE, where the second subscription is a non-default data subscription. In some examples, the registration component 930 is capable of, configured to, or operable to support a means for establishing, using the second subscription, a second registration of the UE for a second network associated with the second subscription based on the second mobile network search, where the second registration is of a home registration type of the set of multiple registration types different from the roaming registration type. The subscription switching component 935 is capable of, configured to, or operable to support a means for switching the second subscription from the non-default data subscription to the default data subscription based on the home registration type of the second registration. The communication component 940 is capable of, configured to, or operable to support a means for communicating with a network entity of the second network using the second subscription based on the switching.

In some examples, to support performing the first mobile network search, the PLMN search component 955 is capable of, configured to, or operable to support a means for performing a search for one or more first available public land mobile networks (PLMNs) for the first subscription to obtain one or more first mobile country codes (MCCs), one or more first mobile network codes (MNCs), or both associated with the one or more first available PLMNs.

In some examples, to support establishing the first registration, the registration code component 985 is capable of, configured to, or operable to support a means for establishing the first registration based on the one or more first MCCs, the one or more first MNCs, or both.

In some examples, to support performing the second mobile network search, the PLMN search component 955 is capable of, configured to, or operable to support a means for performing a search for one or more second available public land mobile networks (PLMNs) for the second subscription to obtain one or more second mobile country codes (MCCs), one or more second mobile network codes (MNCs), or both associated with the one or more second available PLMNs.

In some examples, to support establishing the second registration, the registration code component 985 is capable of, configured to, or operable to support a means for establishing the second registration based on the one or more second MCCs, the one or more second MNCs, or both.

In some examples, the timer component 960 is capable of, configured to, or operable to support a means for initiating a timer based on the first registration being established as the roaming registration type of the set of multiple registration types. In some examples, the registration monitoring component 965 is capable of, configured to, or operable to support a means for monitoring for one or more registration updates using the first subscription, the second subscription, or both. In some examples, the subscription switching component 935 is capable of, configured to, or operable to support a means for switching the second subscription from the non-default data subscription to the default data subscription based on the one or more registration updates.

In some examples, the one or more registration updates include one or more mobile country codes (MCCs), one or more mobile network codes (MNCs), or both associated with a mobile network search using the first subscription, the second subscription, or both.

In some examples, the preference receiver 970 is capable of, configured to, or operable to support a means for receiving one or more inputs indicating a preferred default data subscription. In some examples, the subscription switching component 935 is capable of, configured to, or operable to support a means for refraining from switching the second subscription from the non-default data subscription to the default data subscription based on the one or more inputs.

In some examples, the default data subscription is a default data SIM.

Additionally, or alternatively, the communications manager 920 may support wireless communications in accordance with examples as disclosed herein. In some examples, the mobile network search component 925 is capable of, configured to, or operable to support a means for performing a first mobile network search using a first subscription of a set of multiple subscriptions of the UE. In some examples, the registration component 930 is capable of, configured to, or operable to support a means for establishing, using the first subscription, a first registration for a first network, where the first registration is of a first registration type of a set of multiple registration types. In some examples, the mobile network search component 925 is capable of, configured to, or operable to support a means for performing a second mobile network search using a second subscription of the set of multiple subscriptions of the UE. In some examples, the registration component 930 is capable of, configured to, or operable to support a means for establishing, using the second subscription, a second registration for a second network, where the second registration is of the first registration type of the set of multiple registration types. The subscription parameter component 945 is capable of, configured to, or operable to support a means for transmitting one or more request messages to request a first set of parameters associated with the first network and to request a second set of parameters associated with the second network. The indication receiver 950 is capable of, configured to, or operable to support a means for receiving one or more indications of the first set of parameters and the second set of parameters in response to the one or more request messages. In some examples, the communication component 940 is capable of, configured to, or operable to support a means for communicating via the first network using the first subscription or via the second network using the second subscription based on the first set of parameters and the second set of parameters.

In some examples, to support performing the first mobile network search, the PLMN search component 955 is capable of, configured to, or operable to support a means for performing a search for one or more first available public land mobile networks (PLMNs) for the first subscription to obtain one or more first mobile country codes (MCCs), one or more first mobile network codes (MNCs), or both associated with one or more first available PLMNs.

In some examples, to support establishing the first registration, the registration code component 985 is capable of, configured to, or operable to support a means for establishing the first registration based on the one or more first MCCs, the one or more first MNCs, or both.

In some examples, to support performing the second mobile network search, the PLMN search component 955 is capable of, configured to, or operable to support a means for performing a search for one or more second available public land mobile networks (PLMNs) to obtain one or more second mobile country codes (MCCs), one or more second mobile network codes (MNCs), or both associated with one or more second available PLMNs.

In some examples, to support establishing the second registration, the registration code component 985 is capable of, configured to, or operable to support a means for establishing the second registration based on the one or more second MCCs, the one or more second MNCs, or both.

In some examples, the cost comparing component 980 is capable of, configured to, or operable to support a means for comparing the first set of parameters to the second set of parameters, where the first set of parameters and the second set of parameters respectively include a first cost associated with the first subscription and a second cost associated with the second subscription.

In some examples, the communication component 940 is capable of, configured to, or operable to support a means for communicating via the first network using the first subscription based on the first cost associated with the first subscription being lower than the second cost associated with the second subscription by at least a threshold difference.

In some examples, the subscription parameter component 945 is capable of, configured to, or operable to support a means for transmitting one or more request messages to request a first strength parameter, a first performance parameter, or a first capability associated with the first network and to request a second strength parameter, a second performance parameter, or a second capability associated with the second network based on the first cost associated with the first subscription being separated from the second cost associated with the second subscription by less than a threshold difference. In some examples, the indication receiver 950 is capable of, configured to, or operable to support a means for receiving one or more indications of the first strength parameter, the first performance parameter, or the first capability and the second strength parameter, the second performance parameter, or the second capability in response to the one or more request messages. In some examples, the communication component 940 is capable of, configured to, or operable to support a means for communicating via the first network using the first subscription based on comparing the first strength parameter, the first performance parameter, or the first capability to the second strength parameter, the second performance parameter, or the second capability.

In some examples, the timer component 960 is capable of, configured to, or operable to support a means for initiating one or more timers based on establishing the first registration, the second registration, or both. In some examples, the subscription parameter component 945 is capable of, configured to, or operable to support a means for transmitting the one or more request messages after expiration of at least one of the one or more timers.

In some examples, the preference receiver 970 is capable of, configured to, or operable to support a means for receiving one or more inputs indicating a preferred default data subscription. In some examples, the subscription switching component 935 is capable of, configured to, or operable to support a means for refraining from communicating via the first network using the first subscription or via the second network using the second subscription based on the one or more inputs.

In some examples, the first set of parameters include a first data charge, a first strength parameter, a first performance parameter, or a first capability associated with the first subscription.

In some examples, the second set of parameters include a second data charge, a second strength parameter, a second performance parameter, or a second capability associated with the second subscription.

In some examples, the one or more request messages include an unstructured supplementary service data (USSD) query.

In some examples, the first registration type is a home registration type.

In some examples, the first registration type is a roaming registration type.

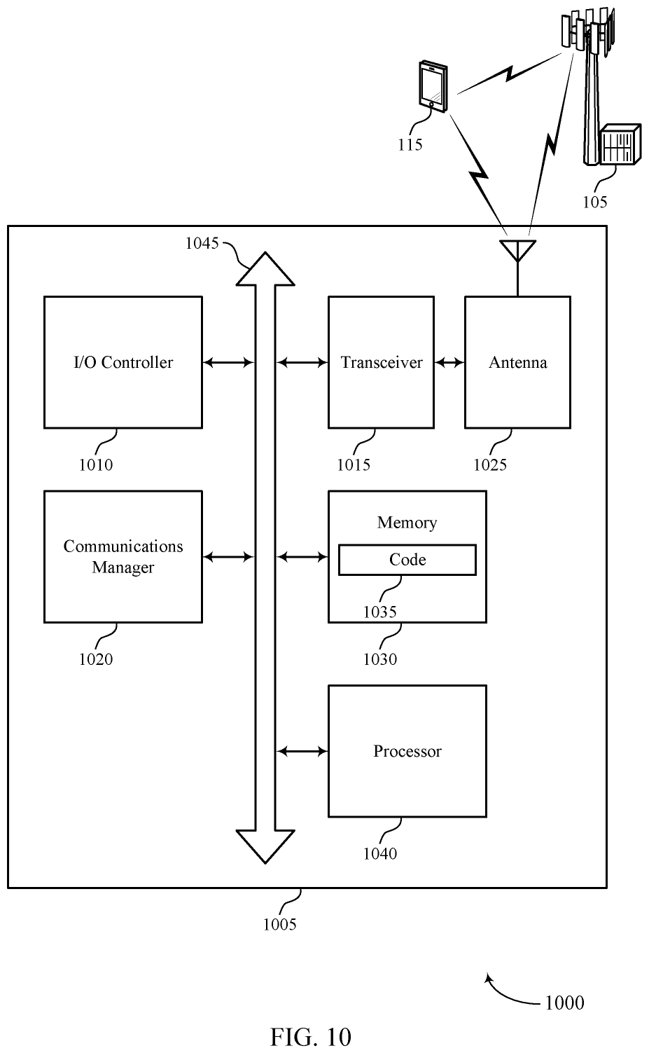

FIG. 10 shows a diagram of a system 1000 including a device 1005 that supports dynamic subscription switching for multi-subscription wireless device in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting dynamic subscription switching for multi-subscription wireless device). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications in accordance with examples as disclosed herein. For example, the communications manager 1020 is capable of, configured to, or operable to support a means for performing a first mobile network search using a first subscription of a set of multiple subscriptions of the UE, where the first subscription is a default data subscription. The communications manager 1020 is capable of, configured to, or operable to support a means for establishing, using the first subscription, a first registration of the UE for a first network associated with the first subscription based on the first mobile network search, where the first registration is of a roaming registration type of a set of multiple registration types. The communications manager 1020 is capable of, configured to, or operable to support a means for performing a second mobile network search using a second subscription of the set of multiple subscriptions of the UE, where the second subscription is a non-default data subscription. The communications manager 1020 is capable of, configured to, or operable to support a means for establishing, using the second subscription, a second registration of the UE for a second network associated with the second subscription based on the second mobile network search, where the second registration is of a home registration type of the set of multiple registration types different from the roaming registration type. The communications manager 1020 is capable of, configured to, or operable to support a means for switching the second subscription from the non-default data subscription to the default data subscription based on the home registration type of the second registration. The communications manager 1020 is capable of, configured to, or operable to support a means for communicating with a network entity of the second network using the second subscription based on the switching.

Additionally, or alternatively, the communications manager 1020 may support wireless communications in accordance with examples as disclosed herein. For example, the communications manager 1020 is capable of, configured to, or operable to support a means for performing a first mobile network search using a first subscription of a set of multiple subscriptions of the UE. The communications manager 1020 is capable of, configured to, or operable to support a means for establishing, using the first subscription, a first registration for a first network, where the first registration is of a first registration type of a set of multiple registration types. The communications manager 1020 is capable of, configured to, or operable to support a means for performing a second mobile network search using a second subscription of the set of multiple subscriptions of the UE. The communications manager 1020 is capable of, configured to, or operable to support a means for establishing, using the second subscription, a second registration for a second network, where the second registration is of the first registration type of the set of multiple registration types. The communications manager 1020 is capable of, configured to, or operable to support a means for transmitting one or more request messages to request a first set of parameters associated with the first network and to request a second set of parameters associated with the second network. The communications manager 1020 is capable of, configured to, or operable to support a means for receiving one or more indications of the first set of parameters and the second set of parameters in response to the one or more request messages. The communications manager 1020 is capable of, configured to, or operable to support a means for communicating via the first network using the first subscription or via the second network using the second subscription based on the first set of parameters and the second set of parameters.

By including or configuring the communications manager 1020 in accordance with examples as described herein, the device 1005 may support techniques for more efficient utilization of communication resources, improved coordination between devices, and improved communication reliability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of dynamic subscription switching for multi-subscription wireless device as described herein, or the at least one processor 1040 and the at least one memory 1030 may be otherwise configured to, individually or collectively, perform or support such operations.

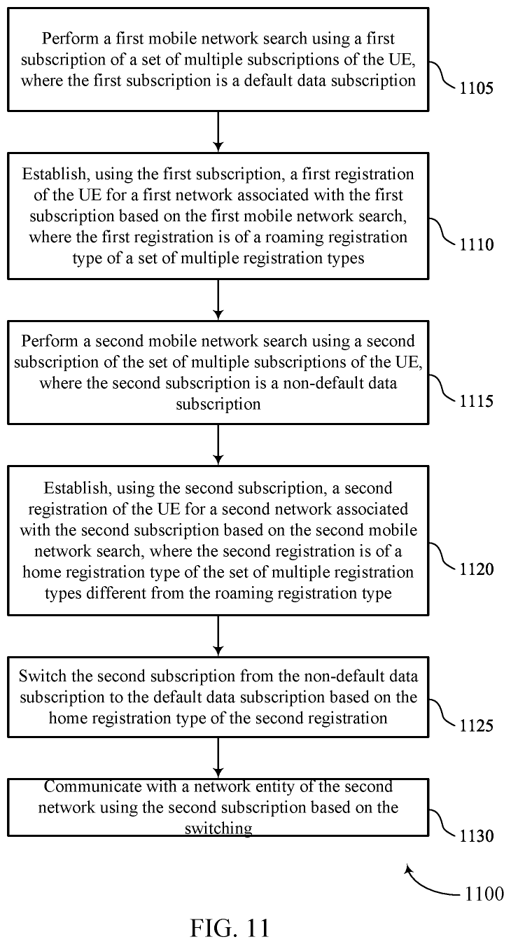

FIG. 11 shows a flowchart illustrating a method 1100 that supports dynamic subscription switching for multi-subscription wireless device in accordance with aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include performing a first mobile network search using a first subscription of a set of multiple subscriptions of the UE, where the first subscription is a default data subscription. The operations of block 1105 may be performed in accordance with examples as disclosed herein. In some examples, aspects of the operations of 1105 may be performed by a mobile network search component 925 as described with reference to FIG. 9.

At 1110, the method may include establishing, using the first subscription, a first registration of the UE for a first network associated with the first subscription based on the first mobile network search, where the first registration is of a roaming registration type of a set of multiple registration types. The operations of block 1110 may be performed in accordance with examples as disclosed herein. In some examples, aspects of the operations of 1110 may be performed by a registration component 930 as described with reference to FIG. 9.

At 1115, the method may include performing a second mobile network search using a second subscription of the set of multiple subscriptions of the UE, where the second subscription is a non-default data subscription. The operations of block 1115 may be performed in accordance with examples as disclosed herein. In some examples, aspects of the operations of 1115 may be performed by a mobile network search component 925 as described with reference to FIG. 9.

At 1120, the method may include establishing, using the second subscription, a second registration of the UE for a second network associated with the second subscription based on the second mobile network search, where the second registration is of a home registration type of the set of multiple registration types different from the roaming registration type. The operations of block 1120 may be performed in accordance with examples as disclosed herein. In some examples, aspects of the operations of 1120 may be performed by a registration component 930 as described with reference to FIG. 9.

At 1125, the method may include switching the second subscription from the non-default data subscription to the default data subscription based on the home registration type of the second registration. The operations of block 1125 may be performed in accordance with examples as disclosed herein. In some examples, aspects of the operations of 1125 may be performed by a subscription switching component 935 as described with reference to FIG. 9.

At 1130, the method may include communicating with a network entity of the second network using the second subscription based on the switching. The operations of block 1130 may be performed in accordance with examples as disclosed herein. In some examples, aspects of the operations of 1130 may be performed by a communication component 940 as described with reference to FIG. 9.

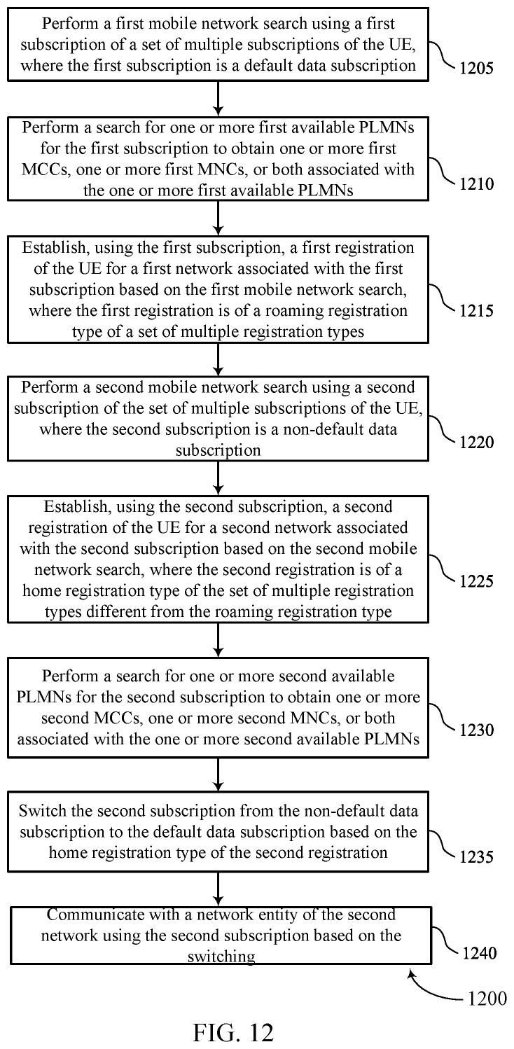

FIG. 12 shows a flowchart illustrating a method 1200 that supports dynamic subscription switching for multi-subscription wireless device in accordance with aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include performing a first mobile network search using a first subscription of a set of multiple subscriptions of the UE, where the first subscription is a default data subscription. The operations of block 1205 may be performed in accordance with examples as disclosed herein. In some examples, aspects of the operations of 1205 may be performed by a mobile network search component 925 as described with reference to FIG. 9.

At 1210, the method may include performing a search for one or more first available public land mobile networks (PLMNs) for the first subscription to obtain one or more first mobile country codes (MCCs), one or more first mobile network codes (MNCs), or both associated with the one or more first available PLMNs. The operations of block 1210 may be performed in accordance with examples as disclosed herein. In some examples, aspects of the operations of 1210 may be performed by an PLMN search component 955 as described with reference to FIG. 9.

At 1215, the method may include establishing, using the first subscription, a first registration of the UE for a first network associated with the first subscription based on the first mobile network search, where the first registration is of a roaming registration type of a set of multiple registration types. The operations of block 1215 may be performed in accordance with examples as disclosed herein. In some examples, aspects of the operations of 1215 may be performed by a registration component 930 as described with reference to FIG. 9.

At 1220, the method may include performing a second mobile network search using a second subscription of the set of multiple subscriptions of the UE, where the second subscription is a non-default data subscription. The operations of block 1220 may be performed in accordance with examples as disclosed herein. In some examples, aspects of the operations of 1220 may be performed by a mobile network search component 925 as described with reference to FIG. 9.

At 1225, the method may include establishing, using the second subscription, a second registration of the UE for a second network associated with the second subscription based on the second mobile network search, where the second registration is of a home registration type of the set of multiple registration types different from the roaming registration type. The operations of block 1225 may be performed in accordance with examples as disclosed herein. In some examples, aspects of the operations of 1225 may be performed by a registration component 930 as described with reference to FIG. 9.

At 1230, the method may include performing a search for one or more second available public land mobile networks (PLMNs) for the second subscription to obtain one or more second mobile country codes (MCCs), one or more second mobile network codes (MNCs), or both associated with the one or more second available PLMNs. The operations of block 1230 may be performed in accordance with examples as disclosed herein. In some examples, aspects of the operations of 1230 may be performed by an PLMN search component 955 as described with reference to FIG. 9.

At 1235, the method may include switching the second subscription from the non-default data subscription to the default data subscription based on the home registration type of the second registration. The operations of block 1235 may be performed in accordance with examples as disclosed herein. In some examples, aspects of the operations of 1235 may be performed by a subscription switching component 935 as described with reference to FIG. 9.

At 1240, the method may include communicating with a network entity of the second network using the second subscription based on the switching. The operations of block 1240 may be performed in accordance with examples as disclosed herein. In some examples, aspects of the operations of 1240 may be performed by a communication component 940 as described with reference to FIG. 9.

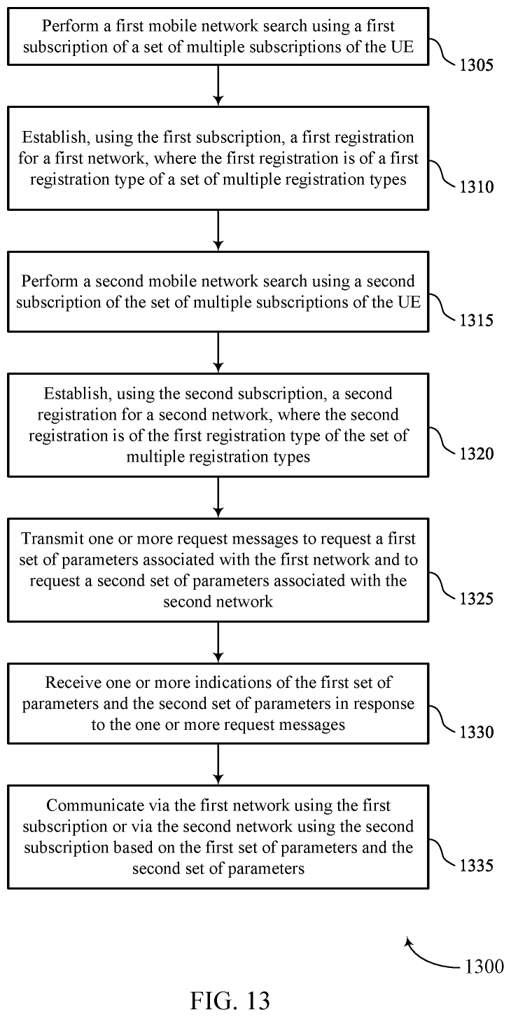

FIG. 13 shows a flowchart illustrating a method 1300 that supports dynamic subscription switching for multi-subscription wireless device in accordance with aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include performing a first mobile network search using a first subscription of a set of multiple subscriptions of the UE. The operations of block 1305 may be performed in accordance with examples as disclosed herein. In some examples, aspects of the operations of 1305 may be performed by a mobile network search component 925 as described with reference to FIG. 9.

At 1310, the method may include establishing, using the first subscription, a first registration for a first network, where the first registration is of a first registration type of a set of multiple registration types. The operations of block 1310 may be performed in accordance with examples as disclosed herein. In some examples, aspects of the operations of 1310 may be performed by a registration component 930 as described with reference to FIG. 9.

At 1315, the method may include performing a second mobile network search using a second subscription of the set of multiple subscriptions of the UE. The operations of block 1315 may be performed in accordance with examples as disclosed herein. In some examples, aspects of the operations of 1315 may be performed by a mobile network search component 925 as described with reference to FIG. 9.

At 1320, the method may include establishing, using the second subscription, a second registration for a second network, where the second registration is of the first registration type of the set of multiple registration types. The operations of block 1320 may be performed in accordance with examples as disclosed herein. In some examples, aspects of the operations of 1320 may be performed by a registration component 930 as described with reference to FIG. 9.

At 1325, the method may include transmitting one or more request messages to request a first set of parameters associated with the first network and to request a second set of parameters associated with the second network. The operations of block 1325 may be performed in accordance with examples as disclosed herein. In some examples, aspects of the operations of 1325 may be performed by a subscription parameter component 945 as described with reference to FIG. 9.

At 1330, the method may include receiving one or more indications of the first set of parameters and the second set of parameters in response to the one or more request messages. The operations of block 1330 may be performed in accordance with examples as disclosed herein. In some examples, aspects of the operations of 1330 may be performed by an indication receiver 950 as described with reference to FIG. 9.

At 1335, the method may include communicating via the first network using the first subscription or via the second network using the second subscription based on the first set of parameters and the second set of parameters. The operations of block 1335 may be performed in accordance with examples as disclosed herein. In some examples, aspects of the operations of 1335 may be performed by a communication component 940 as described with reference to FIG. 9.

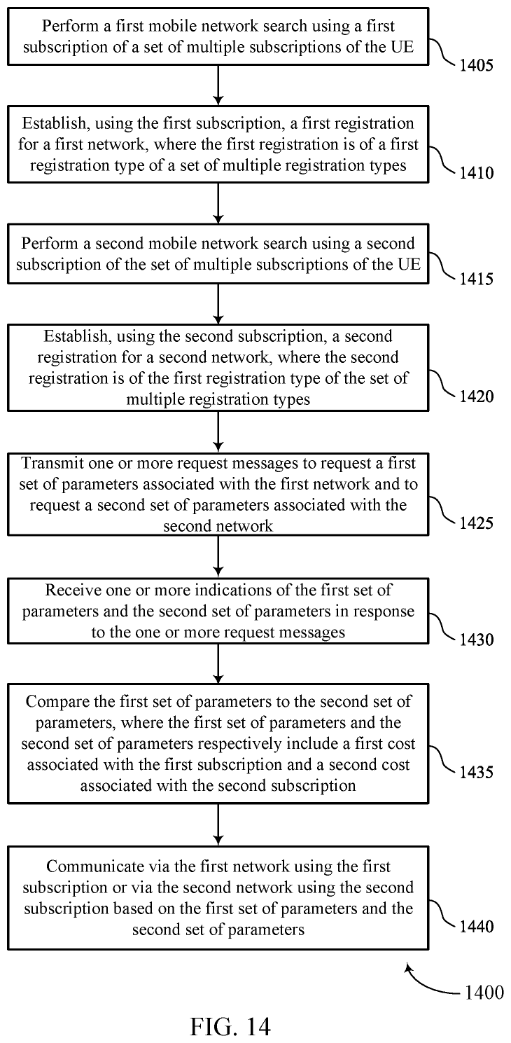

FIG. 14 shows a flowchart illustrating a method 1400 that supports dynamic subscription switching for multi-subscription wireless device in accordance with aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include performing a first mobile network search using a first subscription of a set of multiple subscriptions of the UE. The operations of block 1405 may be performed in accordance with examples as disclosed herein. In some examples, aspects of the operations of 1405 may be performed by a mobile network search component 925 as described with reference to FIG. 9.

At 1410, the method may include establishing, using the first subscription, a first registration for a first network, where the first registration is of a first registration type of a set of multiple registration types. The operations of block 1410 may be performed in accordance with examples as disclosed herein. In some examples, aspects of the operations of 1410 may be performed by a registration component 930 as described with reference to FIG. 9.

At 1415, the method may include performing a second mobile network search using a second subscription of the set of multiple subscriptions of the UE. The operations of block 1415 may be performed in accordance with examples as disclosed herein. In some examples, aspects of the operations of 1415 may be performed by a mobile network search component 925 as described with reference to FIG. 9.

At 1420, the method may include establishing, using the second subscription, a second registration for a second network, where the second registration is of the first registration type of the set of multiple registration types. The operations of block 1420 may be performed in accordance with examples as disclosed herein. In some examples, aspects of the operations of 1420 may be performed by a registration component 930 as described with reference to FIG. 9.

At 1425, the method may include transmitting one or more request messages to request a first set of parameters associated with the first network and to request a second set of parameters associated with the second network. The operations of block 1425 may be performed in accordance with examples as disclosed herein. In some examples, aspects of the operations of 1425 may be performed by a subscription parameter component 945 as described with reference to FIG. 9.

At 1430, the method may include receiving one or more indications of the first set of parameters and the second set of parameters in response to the one or more request messages. The operations of block 1430 may be performed in accordance with examples as disclosed herein. In some examples, aspects of the operations of 1430 may be performed by an indication receiver 950 as described with reference to FIG. 9.

At 1435, the method may include comparing the first set of parameters to the second set of parameters, where the first set of parameters and the second set of parameters respectively include a first cost associated with the first subscription and a second cost associated with the second subscription. The operations of block 1435 may be performed in accordance with examples as disclosed herein. In some examples, aspects of the operations of 1435 may be performed by a cost comparing component 980 as described with reference to FIG. 9.

At 1440, the method may include communicating via the first network using the first subscription or via the second network using the second subscription based on the first set of parameters and the second set of parameters. The operations of block 1440 may be performed in accordance with examples as disclosed herein. In some examples, aspects of the operations of 1440 may be performed by a communication component 940 as described with reference to FIG. 9.

The following provides an overview of aspects of the present disclosure:

Aspect 1: A method for wireless communications by a UE, comprising: performing a first mobile network search using a first subscription of a plurality of subscriptions of the UE, wherein the first subscription is a default data subscription; establishing, using the first subscription, a first registration of the UE for a first network associated with the first subscription based at least in part on the first mobile network search, wherein the first registration is of a roaming registration type of a plurality of registration types; performing a second mobile network search using a second subscription of the plurality of subscriptions of the UE, wherein the second subscription is a non-default data subscription; establishing, using the second subscription, a second registration of the UE for a second network associated with the second subscription based at least in part on the second mobile network search, wherein the second registration is of a home registration type of the plurality of registration types different from the roaming registration type; switching the second subscription from the non-default data subscription to the default data subscription based at least in part on the home registration type of the second registration; and communicating with a network entity of the second network using the second subscription based at least in part on the switching.

Aspect 2: The method of aspect 1, wherein performing the first mobile network search comprises: performing a search for one or more first available PLMNs for the first subscription to obtain one or more first MCCs, one or more first MNCs, or both associated with the one or more first available PLMNs.

Aspect 3: The method of aspect 2, wherein establishing the first registration comprises: establishing the first registration based at least in part on the one or more first MCCs, the one or more first MNCs, or both.

Aspect 4: The method of any of aspects 1 through 3, wherein performing the second mobile network search comprises: performing a search for one or more second available PLMNs for the second subscription to obtain one or more second MCCs, one or more second MNCs, or both associated with the one or more second available PLMNs.

Aspect 5: The method of aspect 4, wherein establishing the second registration comprises: establishing the second registration based at least in part on the one or more second MCCs, the one or more second MNCs, or both.

Aspect 6: The method of any of aspects 1 through 5, further comprising: initiating a timer based at least in part on the first registration being established as the roaming registration type of the plurality of registration types; monitoring for one or more registration updates using the first subscription, the second subscription, or both; and switching the second subscription from the non-default data subscription to the default data subscription based at least in part on the one or more registration updates.

Aspect 7: The method of aspect 6, wherein the one or more registration updates comprise one or more MCCs, one or more MNCs, or both associated with a mobile network search using the first subscription, the second subscription, or both.

Aspect 8: The method of any of aspects 1 through 7, further comprising: receiving one or more inputs indicating a preferred default data subscription; and refraining from switching the second subscription from the non-default data subscription to the default data subscription based at least in part on the one or more inputs.

Aspect 9: The method of any of aspects 1 through 8, wherein the default data subscription is a default data SIM.

Aspect 10: A method for wireless communications by a UE, comprising: performing a first mobile network search using a first subscription of a plurality of subscriptions of the UE; establishing, using the first subscription, a first registration for a first network, wherein the first registration is of a first registration type of a plurality of registration types; performing a second mobile network search using a second subscription of the plurality of subscriptions of the UE; establishing, using the second subscription, a second registration for a second network, wherein the second registration is of the first registration type of the plurality of registration types; transmitting one or more request messages to request a first set of parameters associated with the first network and to request a second set of parameters associated with the second network; receiving one or more indications of the first set of parameters and the second set of parameters in response to the one or more request messages; and communicating via the first network using the first subscription or via the second network using the second subscription based at least in part on the first set of parameters and the second set of parameters.

Aspect 11: The method of aspect 10, wherein performing the first mobile network search comprises: performing a search for one or more first available PLMNs for the first subscription to obtain one or more first MCCs, one or more first MNCs, or both associated with one or more first available PLMNs.

Aspect 12: The method of aspect 11, wherein establishing the first registration comprises: establishing the first registration based at least in part on the one or more first MCCs, the one or more first MNCs, or both.

Aspect 13: The method of any of aspects 10 through 12, wherein performing the second mobile network search comprises: performing a search for one or more second available PLMNs to obtain one or more second MCCs, one or more second MNCs, or both associated with one or more second available PLMNs.

Aspect 14: The method of aspect 13, wherein establishing the second registration comprises: establishing the second registration based at least in part on the one or more second MCCs, the one or more second MNCs, or both.

Aspect 15: The method of any of aspects 10 through 14, further comprising: comparing the first set of parameters to the second set of parameters, wherein the first set of parameters and the second set of parameters respectively comprise a first cost associated with the first subscription and a second cost associated with the second subscription.

Aspect 16: The method of aspect 15, further comprising: communicating via the first network using the first subscription based at least in part on the first cost associated with the first subscription being lower than the second cost associated with the second subscription by at least a threshold difference.

Aspect 17: The method of any of aspects 15 through 16, further comprising: transmitting one or more request messages to request a first strength parameter, a first performance parameter, or a first capability associated with the first network and to request a second strength parameter, a second performance parameter, or a second capability associated with the second network based at least in part on the first cost associated with the first subscription being separated from the second cost associated with the second subscription by less than a threshold difference; receiving one or more indications of the first strength parameter, the first performance parameter, or the first capability and the second strength parameter, the second performance parameter, or the second capability in response to the one or more request messages; and communicating via the first network using the first subscription based at least in part on comparing the first strength parameter, the first performance parameter, or the first capability to the second strength parameter, the second performance parameter, or the second capability.

Aspect 18: The method of any of aspects 10 through 17, further comprising: initiating one or more timers based at least in part on establishing the first registration, the second registration, or both; and transmitting the one or more request messages after expiration of at least one of the one or more timers.

Aspect 19: The method of any of aspects 10 through 18, further comprising: receiving one or more inputs indicating a preferred default data subscription; and refraining from communicating via the first network using the first subscription or via the second network using the second subscription based at least in part on the one or more inputs.

Aspect 20: The method of any of aspects 10 through 19, wherein the first set of parameters comprise a first data charge, a first strength parameter, a first performance parameter, or a first capability associated with the first subscription.

Aspect 21: The method of any of aspects 10 through 20, wherein the second set of parameters comprise a second data charge, a second strength parameter, a second performance parameter, or a second capability associated with the second subscription.

Aspect 22: The method of any of aspects 10 through 21, wherein the one or more request messages comprise an USSD query.

Aspect 23: The method of any of aspects 10 through 22, wherein the first registration type is a home registration type.

Aspect 24: The method of any of aspects 10 through 23, wherein the first registration type is a roaming registration type.

Aspect 25: A UE for wireless communications, comprising one or more memories storing processor-executable code, and one or more processors coupled with the one or more memories and individually or collectively operable to execute the code to cause the UE to perform a method of any of aspects 1 through 9.

Aspect 26: A UE for wireless communications, comprising at least one means for performing a method of any of aspects 1 through 9.

Aspect 27: A non-transitory computer-readable medium storing code for wireless communications, the code comprising instructions executable by a processor to perform a method of any of aspects 1 through 9.

Aspect 28: A UE for wireless communications, comprising one or more memories storing processor-executable code, and one or more processors coupled with the one or more memories and individually or collectively operable to execute the code to cause the UE to perform a method of any of aspects 10 through 24.

Aspect 29: A UE for wireless communications, comprising at least one means for performing a method of any of aspects 10 through 24.

Aspect 30: A non-transitory computer-readable medium storing code for wireless communications, the code comprising instructions executable by a processor to perform a method of any of aspects 10 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
perform a first mobile network search using a first subscription of a plurality of subscriptions of the UE, wherein the first subscription is a default data subscription;
establish, using the first subscription, a first registration of the UE for a first network associated with the first subscription based at least in part on the first mobile network search, wherein the first registration is of a roaming registration type of a plurality of registration types;
perform a second mobile network search using a second subscription of the plurality of subscriptions of the UE, wherein the second subscription is a non-default data subscription;
establish, using the second subscription, a second registration of the UE for a second network associated with the second subscription based at least in part on the second mobile network search, wherein the second registration is of a home registration type of the plurality of registration types different from the roaming registration type;
switch the second subscription from the non-default data subscription to the default data subscription based at least in part on the home registration type of the second registration; and
communicate with a network entity of the second network using the second subscription based at least in part on the switching.

2. The UE of claim 1, wherein, to perform the first mobile network search, the one or more processors are individually or collectively operable to execute the code to cause the UE to:
perform a search for one or more first available public land mobile networks (PLMNs) for the first subscription to obtain one or more first mobile country codes (MCCs), one or more first mobile network codes (MNCs), or both associated with the one or more first available PLMNs.

3. The UE of claim 2, wherein, to establish the first registration, the one or more processors are individually or collectively operable to execute the code to cause the UE to:
establish the first registration based at least in part on the one or more first MCCs, the one or more first MNCs, or both.

4. The UE of claim 1, wherein, to perform the second mobile network search, the one or more processors are individually or collectively operable to execute the code to cause the UE to:
perform a search for one or more second available public land mobile networks (PLMNs) for the second subscription to obtain one or more second mobile country codes (MCCs), one or more second mobile network codes (MNCs), or both associated with the one or more second available PLMNs.

5. The UE of claim 4, wherein, to establish the second registration, the one or more processors are individually or collectively operable to execute the code to cause the UE to:
establish the second registration based at least in part on the one or more second MCCs, the one or more second MNCs, or both.

6. The UE of claim 1, wherein the one or more processors are individually or collectively further operable to execute the code to cause the UE to:
initiate a timer based at least in part on the first registration being established as the roaming registration type of the plurality of registration types;
monitor for one or more registration updates using the first subscription, the second subscription, or both; and
switch the second subscription from the non-default data subscription to the default data subscription based at least in part on the one or more registration updates.

7. The UE of claim 6, wherein the one or more registration updates comprise one or more mobile country codes (MCCs), one or more mobile network codes (MNCs), or both associated with a mobile network search using the first subscription, the second subscription, or both.

8. The UE of claim 1, wherein the one or more processors are individually or collectively further operable to execute the code to cause the UE to:
receive one or more inputs indicating a preferred default data subscription; and
refrain from switching the second subscription from the non-default data subscription to the default data subscription based at least in part on the one or more inputs.

9. The UE of claim 1, wherein the default data subscription is a default data subscriber identity module (SIM).

10. A user equipment (UE), comprising:
one or more memories storing processor-executable code; and
one or more processors coupled with the one or more memories and individually or collectively operable to execute the code to cause the UE to:
perform a first mobile network search using a first subscription of a plurality of subscriptions of the UE;
establish, using the first subscription, a first registration for a first network, wherein the first registration is of a first registration type of a plurality of registration types;
perform a second mobile network search using a second subscription of the plurality of subscriptions of the UE;
establish, using the second subscription, a second registration for a second network, wherein the second registration is of the first registration type of the plurality of registration types;
transmit one or more request messages to request a first set of parameters associated with the first network and to request a second set of parameters associated with the second network;
receive one or more indications of the first set of parameters and the second set of parameters in response to the one or more request messages; and
communicate via the first network using the first subscription or via the second network using the second subscription based at least in part on the first set of parameters and the second set of parameters.

11. The UE of claim 10, wherein, to perform the first mobile network search, the one or more processors are individually or collectively operable to execute the code to cause the UE to:
perform a search for one or more first available public land mobile networks (PLMNs) for the first subscription to obtain one or more first mobile country codes (MCCs), one or more first mobile network codes (MNCs), or both associated with one or more first available PLMNs.

12. The UE of claim 11, wherein, to establish the first registration, the one or more processors are individually or collectively operable to execute the code to cause the UE to:
establish the first registration based at least in part on the one or more first MCCs, the one or more first MNCs, or both.

13. The UE of claim 10, wherein, to perform the second mobile network search, the one or more processors are individually or collectively operable to execute the code to cause the UE to:
perform a search for one or more second available public land mobile networks (PLMNs) to obtain one or more second mobile country codes (MCCs), one or more second mobile network codes (MNCs), or both associated with one or more second available PLMNs.

14. The UE of claim 13, wherein, to establish the second registration, the one or more processors are individually or collectively operable to execute the code to cause the UE to:
establish the second registration based at least in part on the one or more second MCCs, the one or more second MNCs, or both.

15. The UE of claim 10, wherein the one or more processors are individually or collectively further operable to execute the code to cause the UE to:
compare the first set of parameters to the second set of parameters, wherein the first set of parameters and the second set of parameters respectively comprise a first cost associated with the first subscription and a second cost associated with the second subscription.

16. The UE of claim 15, wherein the one or more processors are individually or collectively further operable to execute the code to cause the UE to:
communicate via the first network using the first subscription based at least in part on the first cost associated with the first subscription being lower than the second cost associated with the second subscription by at least a threshold difference.

17. The UE of claim 15, wherein the one or more processors are individually or collectively further operable to execute the code to cause the UE to:
transmit one or more request messages to request a first strength parameter, a first performance parameter, or a first capability associated with the first network and to request a second strength parameter, a second performance parameter, or a second capability associated with the second network based at least in part on the first cost associated with the first subscription being separated from the second cost associated with the second subscription by less than a threshold difference;
receive one or more indications of the first strength parameter, the first performance parameter, or the first capability and the second strength parameter, the second performance parameter, or the second capability in response to the one or more request messages; and
communicate via the first network using the first subscription based at least in part on comparing the first strength parameter, the first performance parameter, or the first capability to the second strength parameter, the second performance parameter, or the second capability.

18. The UE of claim 10, wherein the one or more processors are individually or collectively further operable to execute the code to cause the UE to:
initiate one or more timers based at least in part on establishing the first registration, the second registration, or both; and
transmit the one or more request messages after expiration of at least one of the one or more timers.

19. The UE of claim 10, wherein the one or more processors are individually or collectively further operable to execute the code to cause the UE to:
receive one or more inputs indicating a preferred default data subscription; and
refrain from communicating via the first network using the first subscription or via the second network using the second subscription based at least in part on the one or more inputs.

20. The UE of claim 10, wherein the first set of parameters comprise a first data charge, a first strength parameter, a first performance parameter, or a first capability associated with the first subscription.

21. The UE of claim 10, wherein the second set of parameters comprise a second data charge, a second strength parameter, a second performance parameter, or a second capability associated with the second subscription.

22. The UE of claim 10, wherein the one or more request messages comprise an unstructured supplementary service data (USSD) query.

23. The UE of claim 10, wherein the first registration type is a home registration type.

24. The UE of claim 10, wherein the first registration type is a roaming registration type.

25. A method for wireless communications by a user equipment (UE), comprising:
performing a first mobile network search using a first subscription of a plurality of subscriptions of the UE, wherein the first subscription is a default data subscription;
establishing, using the first subscription, a first registration of the UE for a first network associated with the first subscription based at least in part on the first mobile network search, wherein the first registration is of a roaming registration type of a plurality of registration types;
performing a second mobile network search using a second subscription of the plurality of subscriptions of the UE, wherein the second subscription is a non-default data subscription;
establishing, using the second subscription, a second registration of the UE for a second network associated with the second subscription based at least in part on the second mobile network search, wherein the second registration is of a home registration type of the plurality of registration types different from the roaming registration type;
switching the second subscription from the non-default data subscription to the default data subscription based at least in part on the home registration type of the second registration; and
communicating with a network entity of the second network using the second subscription based at least in part on the switching.

26. The method of claim 25, wherein performing the first mobile network search comprises:
performing a search for one or more first available public land mobile networks (PLMNs) for the first subscription to obtain one or more first mobile country codes (MCCs), one or more first mobile network codes (MNCs), or both associated with the one or more first available PLMNs.

27. The method of claim 26, wherein establishing the first registration comprises:
establishing the first registration based at least in part on the one or more first MCCs, the one or more first MNCs, or both.

28. A method for wireless communications by a user equipment (UE), comprising:
performing a first mobile network search using a first subscription of a plurality of subscriptions of the UE;
establishing, using the first subscription, a first registration for a first network, wherein the first registration is of a first registration type of a plurality of registration types;
performing a second mobile network search using a second subscription of the plurality of subscriptions of the UE;
establishing, using the second subscription, a second registration for a second network, wherein the second registration is of the first registration type of the plurality of registration types;
transmitting one or more request messages to request a first set of parameters associated with the first network and to request a second set of parameters associated with the second network;
receiving one or more indications of the first set of parameters and the second set of parameters in response to the one or more request messages; and
communicating via the first network using the first subscription or via the second network using the second subscription based at least in part on the first set of parameters and the second set of parameters.

29. The method of claim 28, wherein performing the first mobile network search comprises:
performing a search for one or more first available public land mobile networks (PLMNs) for the first subscription to obtain one or more first mobile country codes (MCCs), one or more first mobile network codes (MNCs), or both associated with one or more first available PLMNs.

30. The method of claim 29, wherein establishing the first registration comprises:
establishing the first registration based at least in part on the one or more first MCCs, the one or more first MNCs, or both.
